(19) United States
(12) Patent Application Publication
(10) Pub. No.: US 2026/0118273 A1
(43) Pub. Date: Apr. 30, 2026

(54) INSTRUMENTS AND METHODS FOR PERFORMING OPTICAL ASSAYS

(71) Applicant: Sartorius BioAnalytical Instruments, Inc., Bohemia, NY (US)

(72) Inventors: Tae Kang, Campbell, CA (US); Stewart Holloway, San Jose, CA (US)

(73) Assignee: Sartorius BioAnalytical Instruments, Inc., Bohemia, NY (US)

(21) Appl. No.: 19/163,104

(22) PCT Filed: Mar. 8, 2024
(86) PCT No.: PCT/US2024/019112

§ 371 Date: Sep. 8, 2025

Related U.S. Application Data
(60) Provisional application No. 63/489,354, filed on Mar. 9, 2023.

(51) Int. Cl. G01N 21/77

(52) U.S. Cl. CPC G01N 21/7703

(57) ABSTRACT

Instruments and associated methods arc generally provided. Some instruments described herein may be capable of performing and/or configured to perform two types of optical measurements. Advantageously, this may allow for a single instrument to be employed to perform multiple types of assays on a single sample, to perform multiple types of assays simultaneously, and/or to measure multiple types of optical signals in a single assay.

### RELATED APPLICATIONS

This application claims priority under 35 U.S.C. § 119(e) to U.S. Provisional Application No. 63/489,354, filed Mar. 9, 2023, and entitled “Instruments and Methods for Performing Optical Assays,” which is incorporated herein in its entirety for all purposes.

### FIELD

Instruments for performing optical assays, and associated methods, are generally described.

### BACKGROUND

Scientific instruments may be employed to perform assays. However, such instruments may be limited in the types of assays they can perform and/or the time scales over which they can perform assays.

Accordingly, new instruments and methods that address these concerns would be beneficial.

### SUMMARY

The present disclosure generally describes instruments and methods. The subject matter described herein involves, in some cases, interrelated products, alternative solutions to a particular problem, and/or a plurality of different uses of one or more systems and/or articles.

In some embodiments, an instrument is provided. The instrument comprises a first light source system configured to emit a first type of light, a second light source system configured to emit a second type of light, a first optical detector system configured to detect a first type of optical signal, and a second optical detector system configured to detect a second type of optical signal. The first type of optical signal comprises an amount of the first type of light that has been reflected from an interface internal to a first probe and an amount of the first type of light that has been reflected from the end of the first probe. The second type of optical signal comprises an amount of the second type of light that has been transmitted, reflected, scattered, and/or polarized from a species immobilized on the first probe, an amount of the second type of light that has been transmitted, reflected, scattered, and/or polarized from a species generated from a species immobilized on the first probe, the absence of an amount of the second type of light that has been absorbed by a species immobilized on the first probe, and/or the absence of an amount of the second type of light that has been absorbed by a species generated from a species immobilized on the first probe.

In some embodiments, an instrument comprises a first light source system configured to emit a first type of light, a second light source system configured to emit a second type of light, a first optical detector system configured to detect a first type of optical signal, and a second optical detector system configured to detect a second type of optical signal. The first type of optical signal comprises an amount of the first type of light that has been reflected from an interface internal to a first probe and an amount of the first type of light that has been reflected from the end of the first probe. The second type of optical signal comprises an amount of the second type of light that has been transmitted, reflected, scattered, and/or polarized from a species immobilized on a second probe different from the first probe, an amount of the second type of light that has been transmitted, reflected, scattered, and/or polarized from a species generated from a species immobilized on the second probe, the absence of an amount of the second type of light that has been absorbed by a species immobilized on the second probe, and/or the absence of an amount of the second type of light that has been absorbed by a species generated from a species immobilized on the second probe.

In some embodiments, an instrument comprises a first light source system configured to emit a first type of light, a first optical detector system configured to detect a first type of optical signal, and a second optical detector system configured to detect a second type of optical signal. The first type of optical signal comprises an amount of the first type of light that has been reflected from an interface internal to a first probe and an amount of the first type of light that has been reflected from the end of the first probe. The second type of optical signal comprises an amount of a second type of light that has been emitted from a species immobilized on the first probe and/or an amount of the second type of light that has been emitted from a species generated from a species immobilized on the first probe.

In some embodiments, an instrument comprises a first light source system configured to emit a first type of light, a first optical detector system configured to detect a first type of optical signal, and a second optical detector system configured to detect a second type of optical signal. The first type of optical signal comprises an amount of the first type of light that has been reflected from an interface internal to a first probe and an amount of the first type of light that has been reflected from the end of the first probe. The second type of optical signal comprises an amount of a second type of light that has been emitted from a species immobilized on a second probe different from the first probe and/or an amount of the second type of light that has been emitted from a species generated from a species immobilized on the second probe.

In some embodiments, an instrument comprises a first light source system configured to emit a first type of light, a second light source system configured to emit a second type of light, a first optical detector system configured to detect a first type of optical signal, and a second optical detector system configured to detect a second type of optical signal. The first type of optical signal comprises an amount of the first type of light that has been reflected from an interface internal to a first probe and an amount of the first type of light that has been reflected from the end of the first probe. The second type of optical signal comprises the absence of an amount of the second type of light that has been absorbed by a species immobilized on a second probe and/or the absence of an amount of the second type of light that has been absorbed by a species generated from a species immobilized on the second probe. The second probe is the same probe as the first probe or is a different probe from the first probe.

In some embodiments, an instrument comprises a first light source system configured to emit a first type of light, a first optical detector system configured to detect a first type of optical signal, and a second optical detector system configured to detect a second type of optical signal. The first type of optical signal comprises an amount of the first type of light that has been reflected from an interface internal to a first probe and an amount of the first type of light that has been reflected from the end of the first probe. The second type of optical signal comprises an amount of a second type of light that has been emitted from a species immobilized on a second probe and/or an amount of the second type of light that has been emitted from a species generated from a species immobilized on the second probe. The second probe is the same probe as the first probe or is a different probe from the first probe.

In some embodiments, an instrument comprises a first light source system configured to emit a first type of light, a second light source system configured to emit a second type of light, a first optical detector system configured to detect a first type of optical signal, and a second optical detector system configured to detect a second type of optical signal. The first type of optical signal comprises an amount of the first type of light that has been reflected from an interface internal to a first probe and an amount of the first type of light that has been reflected from the end of the first probe. The second type of optical signal comprises an amount of a second type of light that has been scattered by a species immobilized on a second probe and/or an amount of the second type of light that has been scattered by a species generated from a species immobilized on the second probe. The second probe is the same probe as the first probe or is a different probe from the first probe.

In some embodiments, a method is provided. The method comprises detecting a first type of optical signal with a first optical detector system and detecting a second type of optical signal with a second optical detector system. The first type of optical signal comprises an amount of a first type of light reflected from an interface internal to a first probe and an amount of the first type of light reflected from the end of the first probe. The second type of optical signal comprises an amount of a second type of light that has been transmitted, reflected, scattered, polarized, and/or emitted from a species immobilized on the first probe, an amount of the second type of light that has been transmitted, reflected, scattered, polarized, and/or emitted from a species generated from a species immobilized on the first probe, the absence of an amount of the second type of light that has been absorbed by a species immobilized on the first probe, and/or the absence of an amount of the second type of light that has been absorbed by a species generated from a species immobilized on the first probe.

In some embodiments, a method comprises detecting a first type of optical signal with a first optical detector system and detecting a second type of optical signal with a second optical detector system. The first type of optical signal comprises an amount of a first type of light reflected from an interface internal to a first probe and an amount of a first type of light reflected from the end of the first probe. The second type of optical signal comprises an amount of a second type of light that has been transmitted, reflected, scattered, polarized, and/or emitted from a species immobilized on a second probe different from the first probe, an amount of the second type of light that has been transmitted, reflected, scattered, polarized, and/or emitted from a species generated from a species immobilized on the second probe, the absence of an amount of the second type of light that has been absorbed by a species immobilized on the second probe, and/or the absence of an amount of the second type of light that has been absorbed by a species generated from a species immobilized on the second probe.

In some embodiments, an instrument or method as in any preceding paragraph is provided, wherein the instrument comprises one probe handling system that is configured to translate the first and second probes together.

In some embodiments, an instrument or method as in any preceding paragraph is provided, wherein the instrument comprises a first probe handling system that is configured to translate the first probe and a second probe handling system that is configured to translate the second probe.

In some embodiments, an instrument or method as in any preceding paragraph is provided, wherein the first probe handling system is independent from the second probe handling system.

In some embodiments, an instrument or method as in any preceding paragraph is provided, wherein the interface internal to the first probe extends across the entirety of the cross-section of the first probe.

In some embodiments, an instrument or method as in any preceding paragraph is provided, wherein the interface internal to the first probe extends partially across the cross-section of the first probe, and wherein a portion of the cross-section of the first probe lacks the interface internal to the first probe.

In some embodiments, an instrument or method as in any preceding paragraph is provided, wherein the second probe lacks internal interfaces.

In some embodiments, an instrument or method as in any preceding paragraph is provided, wherein the interface internal to the first probe takes the form of an interface between an interior portion of the first probe and a coating disposed on the interior portion of the first probe.

In some embodiments, an instrument or method as in any preceding paragraph is provided, wherein the interior portion of the first probe comprises SiO₂.

In some embodiments, an instrument or method as in any preceding paragraph is provided, wherein the coating comprises Ta₂O₅.

In some embodiments, an instrument or method as in any preceding paragraph is provided, wherein the first probe further comprises a second coating disposed on the coating, and wherein the second coating comprises SiO₂.

In some embodiments, an instrument or method as in any preceding paragraph is provided, wherein a reagent is immobilized on the first probe.

In some embodiments, an instrument or method as in any preceding paragraph is provided, wherein a reagent is immobilized on the second probe.

In some embodiments, an instrument or method as in any preceding paragraph is provided, wherein the first probe and/or the second probe is capable of transmitting and/or configured to transmit light from the first light source system and/or the second light source system through the probe and/or to a fluid.

In some embodiments, an instrument or method as in any preceding paragraph is provided, wherein the first probe and/or the second probe is capable of transmitting and/or configured to transmit light from a fluid and/or through the probe to the first optical detector system and/or the second optical detector system.

In some embodiments, an instrument or method as in any preceding paragraph is provided, wherein the fluid possibly comprises a species of interest.

In some embodiments, an instrument or method as in any preceding paragraph is provided, wherein the fluid is a fluid present in an assay being performed.

In some embodiments, an instrument or method as in any preceding paragraph is provided, wherein the light is light that makes up the first type of optical signal and/or the second type of optical signal.

In some embodiments, an instrument or method as in any preceding paragraph is provided, wherein the first type of optical signal is detected before the second type of optical signal.

In some embodiments, an instrument or method as in any preceding paragraph is provided, wherein the first and second types of optical signals are detected simultaneously.

In some embodiments, an instrument or method as in any preceding paragraph is provided, wherein the first and second types of optical signals are detected when the first probe is in contact with the same fluid.

In some embodiments, an instrument or method as in any preceding paragraph is provided, wherein the first and second types of optical signals are detected when the first probe is in contact with different fluids.

In some embodiments, an instrument or method as in any preceding paragraph is provided, wherein the first and second types of optical signals are detected when the first and second probes are in contact with different fluids.

In some embodiments, an instrument or method as in any preceding paragraph is provided, wherein the first and second types of optical signals are detected as part of the same assay.

In some embodiments, an instrument or method as in any preceding paragraph is provided, wherein the first and second types of optical signals are detected as parts of different assays.

In some embodiments, an instrument or method as in any preceding paragraph is provided, wherein at least one of the first optical signal and the second optical signal is detected as part of an ELISA assay.

In some embodiments, an instrument or method as in any preceding paragraph is provided, wherein the instrument further comprises a support structure.

In some embodiments, an instrument or method as in any preceding paragraph is provided, wherein the support structure is configured to hold a multiwell plate and/or a test tube array.

In some embodiments, an instrument or method as in any preceding paragraph is provided, wherein the multiwell plate comprises 6, 24, 96, 384, and/or 1536 wells.

In some embodiments, an instrument or method as in any preceding paragraph is provided, wherein the support structure is configured to shake the multiwell plate and/or the test tube array.

In some embodiments, an instrument or method as in any preceding paragraph is provided, wherein the shaking comprises shaking in one, two, and/or three dimensions.

In some embodiments, an instrument or method as in any preceding paragraph is provided, wherein the shaking is performed at a single frequency.

In some embodiments, an instrument or method as in any preceding paragraph is provided, wherein the shaking is capable of being performed and/or is performed at multiple frequencies.

In some embodiments, an instrument or method as in any preceding paragraph is provided, wherein the support structure comprises a heater and/or a cooler.

In some embodiments, an instrument or method as in any preceding paragraph is provided, wherein the second light source system is configured to emit a third type of light.

In some embodiments, an instrument or method as in any preceding paragraph is provided, wherein the second light source system comprises a light source, and wherein the light source comprises a xenon flash lamp, a tungsten halogen lamp, an LED, and/or a laser diode.

In some embodiments, an instrument or method as in any preceding paragraph is provided, wherein the second optical detector system comprises an optical detector, and wherein the optical detector comprises a photomultiplier tube, a photodiode, a photodiode array, an avalanche photodiode, a CMOS sensor, and/or a CCD.

In some embodiments, an instrument or method as in any preceding paragraph is provided, wherein the second type of light is emitted via luminescence.

In some embodiments, an instrument or method as in any preceding paragraph is provided, wherein the emission of the second type of light is stimulated by the third type of light.

In some embodiments, an instrument or method as in any preceding paragraph is provided, wherein the second light source system further comprises a wavelength selector positioned between the light source and the first probe and/or the second probe.

In some embodiments, an instrument or method as in any preceding paragraph is provided, wherein the wavelength selector comprises a filter, a diffraction grating, and/or a prism.

In some embodiments, an instrument or method as in any preceding paragraph is provided, wherein the second optical detector system further comprises a wavelength selector positioned between the first probe and/or the second probe and the optical detector.

In some embodiments, an instrument or method as in any preceding paragraph is provided, wherein the instrument further comprises a bandwidth selector.

In some embodiments, an instrument or method as in any preceding paragraph is provided, wherein the instrument comprises a light source system switch that is configured to determine which light source system illuminates the first probe.

In some embodiments, an instrument or method as in any preceding paragraph is provided, wherein the instrument comprises a light source system switch that is configured to determine which light source system illuminates both the first probe and the second probe.

In some embodiments, an instrument or method as in any preceding paragraph is provided, wherein the instrument comprises an optical detector system switch that is configured to determine which optical detector system receives light from the first probe.

In some embodiments, an instrument or method as in any preceding paragraph is provided, wherein the instrument comprises an optical detector system switch that is configured to determine which optical detector system receives light from both the first probe and the second probe.

In some embodiments, an instrument or method as in any preceding paragraph is provided, wherein the first light source system illuminates the first probe while the second light source system illuminates the second probe.

In some embodiments, an instrument or method as in any preceding paragraph is provided, wherein the first optical detector system receives light from the first probe while the second optical detector system receives light from the second probe.

In some embodiments, an instrument or method as in any preceding paragraph is provided, wherein the first light source system illuminates the first probe while the second light source system also illuminates the first probe.

In some embodiments, an instrument or method as in any preceding paragraph is provided, wherein the first optical detector system receives light from the first probe while the second optical detector system also receives light from the first probe.

In some embodiments, an instrument or method as in any preceding paragraph is provided, wherein the instrument comprises a third light source system configured to emit a third type of light.

In some embodiments, an instrument or method as in any preceding paragraph is provided, wherein the instrument comprises a third light source system configured to detect a third type of optical signal.

In some embodiments, an instrument or method as in any preceding paragraph is provided, wherein the third type of optical signal comprises an amount of the third type of light that has been transmitted, reflected, scattered, and/or polarized from a species immobilized on a third probe, an amount of the third type of light that has been transmitted, reflected, scattered, and/or polarized from a species generated from a species immobilized on the third probe, the absence of an amount of the third type of light that has been absorbed by a species immobilized on the third probe, and/or the absence of an amount of the second type of light that has been absorbed by a species generated from a species immobilized on the third probe.

In some embodiments, an instrument or method as in any preceding paragraph is provided, wherein the third type of optical signal comprises an amount of a fourth type of light that has been emitted from a species immobilized on the third probe, and/or an amount of the fourth type of light that has been emitted from a species generated from a species immobilized on the third probe.

In some embodiments, an instrument or method as in any preceding paragraph is provided, wherein the third probe is the same probe as the first probe and/or the second probe.

In some embodiments, an instrument or method as in any preceding paragraph is provided, wherein the third probe is a different probe from the first probe and/or the second probe.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1 shows one non-limiting embodiment of an instrument comprising two optical detector systems, in accordance with some embodiments;

FIG. 2 shows one non-limiting embodiment of an instrument comprising two optical detector systems and a single light source system, in accordance with some embodiments;

FIG. 3 schematically depicts an instrument comprising two light source systems, in accordance with some embodiments;

FIG. 4 shows one non-limiting example of an instrument comprising a probe handling system, in accordance with some embodiments;

FIG. 5 shows one example of a probe handling system holding a single probe, in accordance with some embodiments;

FIG. 6 shows one example of a probe handling system holding a first probe and a second probe, in accordance with some embodiments;

FIG. 7 shows one non-limiting example of an instrument comprising a first probe handling system holding a first probe and a second probe handling system holding a second probe, in accordance with some embodiments;

FIG. 8 shows one non-limiting example of an instrument comprising a support structure, in accordance with some embodiments;

FIG. 9 shows one exemplary method, in accordance with some embodiments;

FIG. 10 depicts schematically one example of a process by which an optical signal comprising both an amount of the light that has been reflected from an interface internal to a probe and an amount of light that has been reflected from the end of a first probe can be generated, in accordance with some embodiments;

FIG. 11 schematically depicts a probe including an internal interface, in accordance with some embodiments;

FIG. 12 schematically depicts a probe comprising an internal interface that takes the form of an interface between an interior portion of the probe and a coating disposed on the interior portion of the probe, in accordance with some embodiments;

FIG. 13 schematically depicts a probe comprising two coatings, in accordance with some embodiments;

FIG. 14 schematically depicts a probe comprising an internal interface that extends only across a portion of the probe cross-section, in accordance with some embodiments;

FIG. 15 shows one non-limiting example of a probe that comprises two optical fibers, in accordance with some embodiments;

FIG. 16 depicts one non-limiting example of an exemplary instrument, in accordance with some embodiments;

FIGS. 17-19 are photographs of optical switches, in accordance with some embodiments;

FIG. 20 shows experimental time-resolved fluorescence data, in accordance with some embodiments;

FIG. 21 shows experimentally obtained signals, in accordance with some embodiments;

FIG. 22 shows experimentally obtained optical signals for various samples recorded during an assay as a function of time, in accordance with some embodiments; and

FIG. 23 shows absorbance optical signals for various samples, in accordance with some embodiments.

### DETAILED DESCRIPTION

Instruments and associated methods are generally provided. Some instruments described herein may be capable of performing and/or configured to perform two types of optical measurements. Advantageously, this may allow for a single instrument to be employed to perform multiple types of assays on a single sample, to perform multiple types of assays simultaneously, and/or to measure multiple types of optical signals in a single assay. Further advantages that may be associated with the instruments and methods described herein include automated assay performance, short assay time, real-time assay monitoring, and/or relatively high sensitivity.

In some embodiments, an instrument described herein is capable of detecting and/or configured to detect two types of optical signals that are complementary. For instance, an instrument may be capable of detecting and/or configured to detect one type of optical signal that is generated relatively quickly and a second, different type of optical signal that yields information that is relatively precise. Collecting both such types of optical signals during a single assay may allow for both rapid determination of one feature of the sample (e.g., whether a desired reaction has occurred) and precise determination of another feature of the sample (e.g., the extent to which the reaction has occurred). As another example, an instrument may be capable of detecting and/or configured to detect two types of optical signals that provide different information regarding the sample and/or the assay. For instance, an instrument may be capable of detecting and/or configured to detect whether two different species are present in a sample.

Some embodiments relate to methods. In some embodiments, a method comprises detecting two types of optical signals, which may be advantageous for the reasons described above. Some methods described herein may be capable of being performed in the instruments described herein. Some instruments described herein may be capable of performing and/or configured to perform the methods described herein.

The instruments described herein may comprise a variety of components. An overview of exemplary instrument designs and associated components is provided in further detail below.

In some embodiments, an instrument comprises one or more light source systems and one or more optical detector systems. Each light source system may be capable of emitting and/or configured to emit a type of light. Each optical detector system may be capable of detecting and/or configured to detect an optical signal. In some embodiments, an instrument comprises one or more pairs of light source systems and optical detector systems. In such pairs, a light source system may be capable of emitting and/or configured to emit a type of light that is capable of generating and/or configured to generate a type of optical signal that the detector system is capable of detecting and/or configured to detect. Such pairs may serve, together, to provide the conditions (e.g., optical conditions, such as light exposure) to both generate and detect a particular type of optical signal and/or the absence thereof. It is of course also possible for an instrument to comprise an optical detector system that is unpaired with a light source system. Such optical detectors may be capable of detecting and/or configured to detect a type of optical signal that is generated independently of the exposure to a particular type of light.

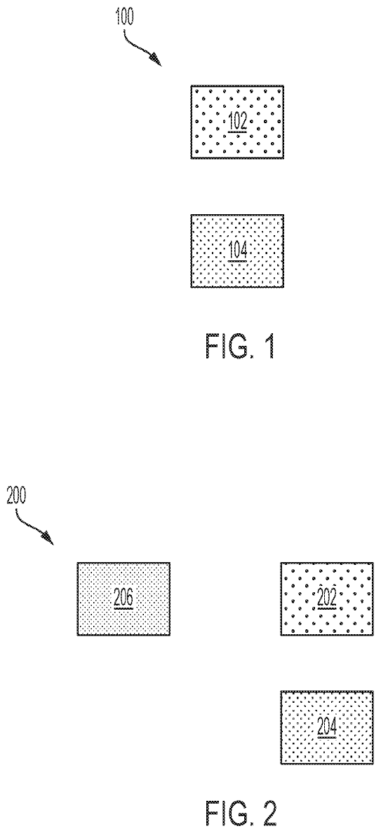

In some embodiments, an instrument comprises at least two optical detector systems, each capable of detecting and/or configured to detect a type of optical signal. In some such instruments, the two optical detector systems (and/or each optical detector system) may be capable of detecting and/or configured to detect different types of optical signals from each other. FIG. 1 shows one non-limiting embodiment of an instrument comprising two optical detector systems. In FIG. 1, the instrument 100 comprises a first optical detector system 102 and a second optical detector system 104. As discussed in further detail below, it is also possible for an instrument to comprise three or more optical detector systems.

In some embodiments, an instrument comprises at least one light source system. FIG. 2 shows one non-limiting embodiment of an instrument 200 comprising two optical detector systems 202 and 204 and a single light source system 206. As described above, in some embodiments, an instrument comprises a light source system that is capable of emitting and/or configured to emit a first type of light and a first optical detector that is capable of detecting and/or configured to detect a signal generated from the first type of light. An instrument having the design shown in FIG. 2 may have these features when the first optical detector system 202 is capable of detecting and/or configured to detect an optical signal generated from the type of light that the first light source system 206 is capable of emitting and/or configured to emit.

In some embodiments, like the embodiment shown in FIG. 2, an instrument comprises an optical detector system that is capable of detecting and/or configured to detect an optical signal that is generated independently of the exposure to a particular type of light. For instance, an instrument may comprise an optical detector system that is capable of detecting and/or configured to detect an optical signal that arises from luminescence (e.g., chemiluminescence). With respect to FIG. 2, the second optical detector system 204 is not paired with any light source systems. It may be capable of detecting and/or configured to detect an optical signal that is not generated by any light source system present in the instrument.

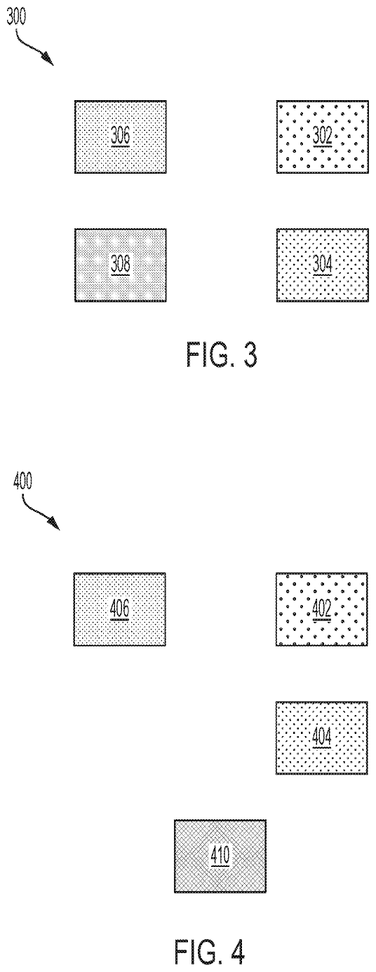

In some embodiments, an instrument comprises two light source systems and two optical detector systems. In some such embodiments, the first and second light source systems (and/or each light source system present) may be capable of emitting and/or configured to emit different types of light from each other. FIG. 3 schematically depicts an instrument comprising two light source systems. The instrument 300 shown in FIG. 3 comprises a first optical detector system 302, a second optical detector system 304, a first light source system 306, and a second light source system 308. The first optical detector system 302 may be capable of detecting and/or configured to detect an optical signal generated from the type of light that the first light source system 306 is capable of emitting and/or configured to emit. The second optical detector system 304 may be capable of detecting and/or configured to detect an optical signal generated from the type of light that the second light source system 308 is capable of emitting and/or configured to emit. Instruments having the design shown in FIG. 3 may be capable of and/or configured to emit two types of light (e.g., two different types of light) and detect two types of optical signals (e.g., two different types of optical signals). As discussed in further detail below, it is also possible for an instrument to comprise three or more light source systems. Such instruments may be capable of emitting three or more types of light (e.g., three or more different types of light) and detecting three or more types of optical signals (e.g., three or more different types of optical signals).

In some embodiments, an instrument is capable of operating and/or configured to operate in conjunction with one or more probes. The one or more probes may have one or more features that facilitate the detection of an optical signal. For instance, a probe may be capable of transmitting and/or configured to transmit light from a light source system through the probe and/or to a fluid (e.g., a fluid possibly comprising a species of interest, a fluid present in an assay being performed). As another example, a probe may be capable of transmitting and/or configured to transmit light (e.g., light making up an optical signal, such as a first optical signal, a second optical signal, and/or a third optical signal) from a fluid and/or through the probe to an optical detector system. As a third example, a probe may comprise one or more features (e.g., one or more structural features) that assist with optical signal generation.

It is possible for an instrument to be capable of operating and/or configured to operate in conjunction with one or more probes that are each capable of interfacing with and/or configured to interface with two or more optical detection systems and/or two or more light source systems (e.g., two or more pairs of paired optical detection systems and light source systems). In such instances, such probe(s) may be capable of performing and/or configured to perform one or more of the actions described in the preceding paragraph with respect to two or more light source systems and/or two or more optical detector systems. It is also possible for an instrument to be capable of operating and/or configured to operate in conjunction with a plurality of probes (e.g., two or more probes, three or more probes), each of which is capable of interfacing with and/or configured to interface with a different optical detection system and/or a different light source system (e.g., a different pair of a paired optical detection systems and light source systems). In such instances, each probe may be capable of performing and/or configured to perform one or more of the actions described in the preceding paragraph with respect to a single light source system and/or a single optical detector system.

In some embodiments, an instrument is capable of operating and/or configured to operate such that one or more probes are illuminated simultaneously by different light source systems.

For instance, an instrument may be capable of operating and/or configured to operate such that a first light source system illuminates a first probe while a second light source system also illuminates the first probe. As another example, an instrument may be capable of operating and/or configured to operate such that a first light source system illuminates a first probe while a second light source system illuminates a second probe. In some such embodiments, a third light source system illuminates a third probe. It is also possible for different light source systems to illuminate probes sequentially (e.g., first and second light source systems may sequentially illuminate a first probe, a first light source system may illuminate a first probe and then a second light source system may illuminate a second probe).

In some embodiments, an instrument is capable of operating and/or configured to operate such that two or more probes are illuminated by a common light source system. For instance, an instrument may be capable of operating and/or configured to operate such that a first light source system illuminates both a first probe and a second probe. It is also possible for an instrument to be capable of operating and/or configured to operate such that groups of probes are illuminated by different light source systems. As one example, an instrument may be capable of operating and/or configured to operate such that a first light source system illuminates a first probe and a second probe and a second light source system illuminates a third probe and a fourth probe. It is also possible for two or more groups of light source systems to illuminate a common group of probes.

In some embodiments, an instrument is capable of operating and/or configured to operate such that two or more optical detector systems receive light from a probe or set of probes simultaneously. For instance, an instrument may be capable of operating and/or configured to operate such that a first optical detector system receives light from a first probe while a second optical detector system also receives light from the first probe. As another example, an instrument may be capable of operating and/or configured to operate such that a first optical detector system receives light from a first probe while a second optical detector system receives light from a second probe. In some such embodiments, a third optical detector system receives light from a third probe. It is also possible for different optical detector systems to receive light from probes sequentially (e.g., first and second optical detector systems may sequentially receive light from a first probe, an optical detector system may receive light from a first probe and then a second light optical detector system may receive light from a second probe).

In some embodiments, an instrument is capable of operating and/or configured to operate such that two or more groups of optical detector systems receive light from two or more groups of probes. For instance, an instrument may be capable of operating and/or configured to operate such that a first group of optical detector systems receives light from a first group of probes and a second group of optical detector systems receives light from a second group of probes. It is also possible for two or more groups of optical detector systems to receive light from a common group of probes.

When an instrument is capable of operating and/or configured to operate in conjunction with two or more probes, the probes may be arranged with respect to the light source systems such that light is transmitted thereto serially and/or in parallel.

The instruments described herein may comprise one or more switches. Such switches may determine which light source systems illuminate which probes and/or which optical detector systems receive light from which probes.

In some embodiments, an instrument described herein comprises a light source system switch that is capable of determining and/or configured to determine which light source system illuminates a probe (e.g., a first probe, a second probe, a third probe). Such a switch may have one setting that places a first light source system in optical communication with the probe, one setting that places a second light source system in optical communication with the probe, and/or one setting that places no light source system in optical communication with the probe. It is also possible for such a switch to have a setting that places two or more light source systems in optical communication with the probe simultaneously.

In some embodiments, an instrument described herein comprises a light source system switch that is configured to determine and/or capable of determining which light source system illuminates two or more probes. In other words, the light source system that illuminates two or more probes may be controlled by a common switch, which may cause the two or more probes to be illuminated by the same light source system. Such a switch may have one setting that places a first light source system in optical communication with the two or more probes, one setting that places a second light source system in optical communication with the two or more probes, and/or one setting that places no light source system in optical communication with the two or more probes. It is also possible for such a switch to have a setting that places two light source systems in optical communication with all of the two or more probes simultaneously.

One non-limiting example of a suitable light source system switch is a motorized mirror flip. The motorized mirror flip may comprise a mirror whose orientation can be flipped to place different light sources in optical communication with a probe and/or with two or more probes.

In some embodiments, an instrument described herein comprises an optical detector system switch that is capable of determining and/or configured to determine which optical detector system receives light from a probe (e.g., a first probe, a second probe, a third probe).

Such a switch may have one setting that places a first optical detector system in optical communication with the probe, one setting that places a second optical detector system in optical communication with the probe, and/or one setting that places no optical detector system in optical communication with the probe. It is also possible for such a switch to have a setting that places two optical detector systems in optical communication with the probe simultaneously.

In some embodiments, an instrument described herein comprises an optical detector system switch that is configured to determine and/or capable of determining which optical detector system receives light from two or more probes. In other words, the optical detector system receives light from two or more probes may be controlled by a common switch, which may cause the same optical detector system to receive light from the two or more probes. Such a switch may have one setting that places a first optical detector system in optical communication with the two or more probes, one setting that places a second optical detector system in optical communication with the two or more probes, and/or one setting that places no optical detector system in optical communication with the two or more probes. It is also possible for such a switch to have a setting that places two optical detector systems in optical communication with all of the two or more probes simultaneously.

As described above, it is also possible for an instrument to have a design such that it includes a first light source system that is capable of illuminating and/or configured to illuminate a first probe while a second light source is capable of illuminating and/or configured to illuminate a second probe. Some instruments may comprise further probes that may be capable of being and/or configured to be illuminated by further light sources while the first and second probes are illuminated. Such instruments may lack switches (e.g., the first light source system may be in irreversible optical communication with the first probe, the second light source system may be in irreversible communication with the second probe, and any further light source systems may be in irreversible communication with any further probes) or may include one or more switches. For instance, an instrument may include a single switch that simultaneously determines which light source systems illuminate the probes (e.g., the first probe, the second probe, and any further probes) and have a design such that it selects different light source systems to illuminate each probe. As another example, an instrument may include a first switch that determines which light source system illuminates the first probe, a second switch that determines which light source system illuminates the second probe, and possibly further switches that determine which light source system(s) illuminate any further probes.

Similarly, and as also described above, an instrument may have a design such that it includes a first optical detector system that is capable of receiving and/or configured to receive light from a first probe while a second light source is capable of receiving and/or configured to receive light from a second probe. Some instruments may comprise further optical detector systems that may be capable of receiving and/or configured to receive light from further probes. Such instruments may lack switches (e.g., the first optical detector system may be in irreversible optical communication with the first probe, the second optical detector system may be in irreversible communication with the second probe, and any further light source systems may be in irreversible communication with any further probes) or may include one or more switches. For instance, an instrument may include a single switch that simultaneously determines which optical detector systems receive light from the probes (e.g., the first probe, the second probe, and any further probes) and have a design such that it selects different optical detector systems to receive light from each probe. As another example, an instrument may include a first switch that determines which optical detector system receives light from the first probe, a second switch that determines which optical detector system receives light from the second probe, and possibly further switches that determine which optical detector system(s) receive light from any further probes.

In some embodiments, an instrument comprises a probe handling system that is capable of holding and/or configured to hold one or more probes at one or more locations (e.g., proximate to a fluid, in contact with a fluid). A probe handling system may be capable of holding and/or configured to hold two or more probes (e.g., three or more probes) proximate to each other (e.g., in contact with and/or proximate to a common fluid). It is also possible for a probe handling system to be capable of holding and/or configured to hold two or more probes (e.g., three or more probes) distal to each other (e.g., in contact with and/or proximate to different fluids). Probe handling systems may hold probes in a variety of suitable manners, including comprising an opening into which a probe may be inserted and/or comprising a component that is capable of mechanically coupling and/or configured to mechanically couple the probe to the probe handling system (e.g., clamps). It is also possible for a probe handling system to comprise one or more components that provide rigid support to a probe and/or protect the probe from damage (e.g., an epoxy).

Some probe handling systems may be capable of translating and/or configured to translate one or more probes. Probe handling systems may be capable of translating and/or configured to translate two or more probes together (e.g., such that the distance between the two or more probes remains constant during the translation and/or such that the two or more probes are translated according to a common set of instructions). It is also possible for a probe handling system to be capable of translating and/or configured to translate two or more probes partially together and partially separately (e.g., the probe handling system may be designed such that the two or more probes may be placed in a common holder that may be translated, and one or more probes may also be capable of being translated and/or configured to be translated with respect to the holder).

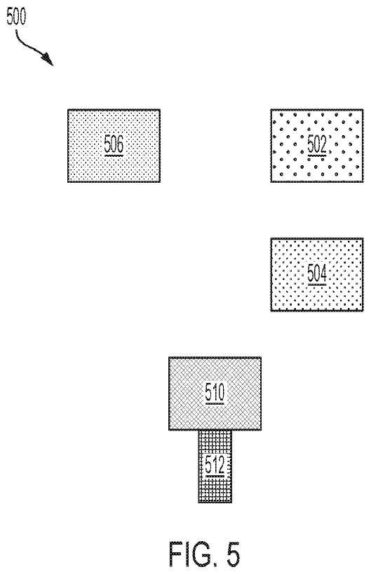

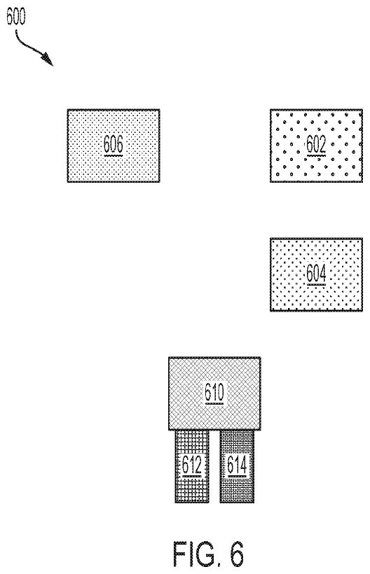

FIG. 4 shows one non-limiting example of an instrument comprising a probe handling system. In FIG. 4, the instrument 400 comprises the probe handling system 410. FIG. 5 shows one example of a probe handling system 510 holding a single probe 512 and FIG. 6 shows one example of a probe handling system 610 holding a first probe 612 and a second probe 614.

In some embodiments, an instrument comprises two or more probe handling systems. Each probe handling system may be capable of holding and/or configured to hold a different probe. For instance, in some embodiments, one probe handling system may be capable of holding and/or configured to hold a probe that is capable of interfacing with and/or configured to interface with one optical detection system and/or one light source system. As another example, an instrument may comprise a plurality of probe handling systems, each capable of holding and/or configured to hold a different probe, and for which each probe is capable of interfacing with and/or configured to interface with a different optical detection system and/or a different light source system. In some embodiments, different probe handling systems may be capable of translating and/or configured to translate the probes that they are capable of holding and/or configured to hold. For instance, they may be capable of translating and/or configured to translate such probes separately (e.g., independently from each other).

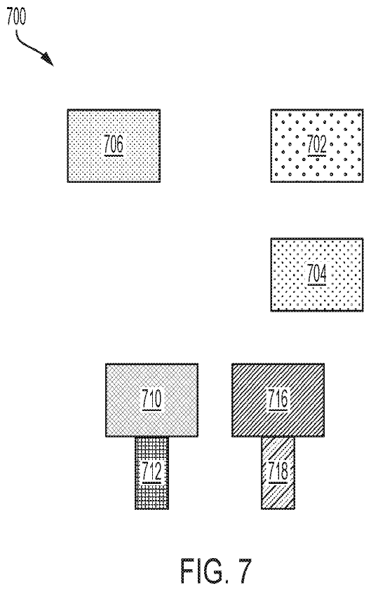

FIG. 7 shows one non-limiting example of an instrument 700 comprising a first probe handling system 710 holding a first probe 712 and a second probe handling system 716 holding a second probe 718.

Probe handling systems may translate probes between a variety of suitable locations. The translation may comprise vertical translation and/or horizontal translation. As one example, in some embodiments, a probe handling system may be capable of translating and/or configured to be translate a probe from a first location (e.g., a resting location, a storage location, a location at which one or more probes may be positioned thereon, a first location proximal to and/or in contact with a fluid) to and/or from a second location (e.g., a location and/or a second location proximal to a fluid and/or in contact with a fluid). In some embodiments, a probe and/or probes are positioned on and/or removed from the probe handling system at the first location. In some embodiments, the second location allows for the generation and/or detection of an optical signal (e.g., upon contact of a fluid in a container held by the support structure with a probe).

It is also possible for an instrument to comprise a stationary probe handling system and/or to lack a probe handling system.

In some embodiments, an instrument comprises a support structure. The support structure may be capable of holding and/or configured to hold one or more containers for a fluid and/or a container for one or more fluids. The holding may comprise serving as a platform on which the container(s) may be disposed (e.g., a support structure may take the form of a flat plate on which one or more container(s) may be positioned), may comprise partially or fully surrounding the container(s) laterally, may comprise suspending the container(s), and/or may comprise securing the container(s) in one or more ways (e.g., a support structure may include one or more structures into which one or more containers may be disposed, such as a test tube rack; a support structure may comprise one or more fasteners, clamps, and/or other elements that restrict movement of the container(s) with respect to the support structure). Non-limiting examples of such containers include multiwell plates (e.g., comprising 6, 24, 96, 384, and/or 1536 wells), test tubes, test tube arrays, microtiter plates, glass slides, droplet arrays, vials, microfluidic devices, microfluidic arrays, microarrays, and digital microfluidic chips. The fluid(s) may be sample(s) to be analyzed by the instrument and/or may be fluid(s) that are present in an assay that the instrument is capable of performing and/or configured to perform. In some embodiments, a support structure is capable of positioning and/or is configured to position the container(s) proximal to one or more probes (e.g., such that the probe(s) may be capable of Making contact with the fluid contained therein).

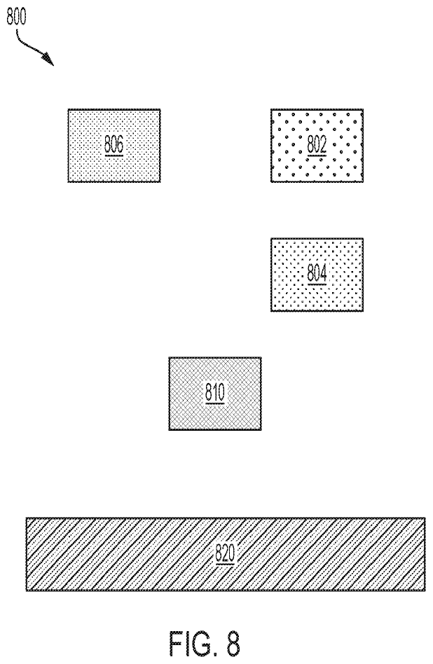

FIG. 8 shows one non-limiting example of an instrument 800 comprising a support structure 820.

Some support structures may be capable of translating and/or configured to be translated. The translation may comprise vertical translation and/or horizontal translation. As one example, in some embodiments, a support structure may be capable of translating and/or configured to be translated from a first location (e.g., a resting location, a storage location, a location at which one or more containers may be positioned thereon, a first location proximal to and/or in contact with a probe) to and/or from a second location (e.g., a location and/or a second location proximal to a probe and/or in contact with a probe). In some embodiments, the container and/or containers are positioned on and/or removed from the support structure at the first location. In some embodiments, the second location allows for the generation and/or detection of an optical signal (e.g., upon contact of a fluid in a container held by the support structure with a probe).

Translation may be accomplished manually and/or automatically. In some embodiments, translation is effected by a motor.

It is also possible for an instrument to comprise a stationary support structure and/or to lack a support structure.

In some embodiments, a support structure may be capable of shaking and/or may be configured to shake. Without wishing to be bound by any particular theory, it is believed that shaking may promote mixing of components within fluids contained in containers held by the support structure. Accordingly, in some embodiments, a support structure may be capable of shaking and/or configured to shake a container held by the support structure. The shaking may comprise shaking in one, two, and/or three dimensions. The shaking may comprise shaking at a single frequency. It is also possible for a support structure to be capable of shaking and/or configured to shake at multiple frequencies (e.g., at different points in time, simultaneously).

In some embodiments, a support structure comprises a heater and/or a cooler. Such components may be capable of supplying and/or configured to supply and remove heat, respectively, from the support structure, containers held thereby, and/or fluid contained by such containers. In some embodiments, a heater and/or a cooler may be configured to maintain and/or be capable of maintaining the support structure, one or more containers held thereby, and/or a fluid at a particular temperature.

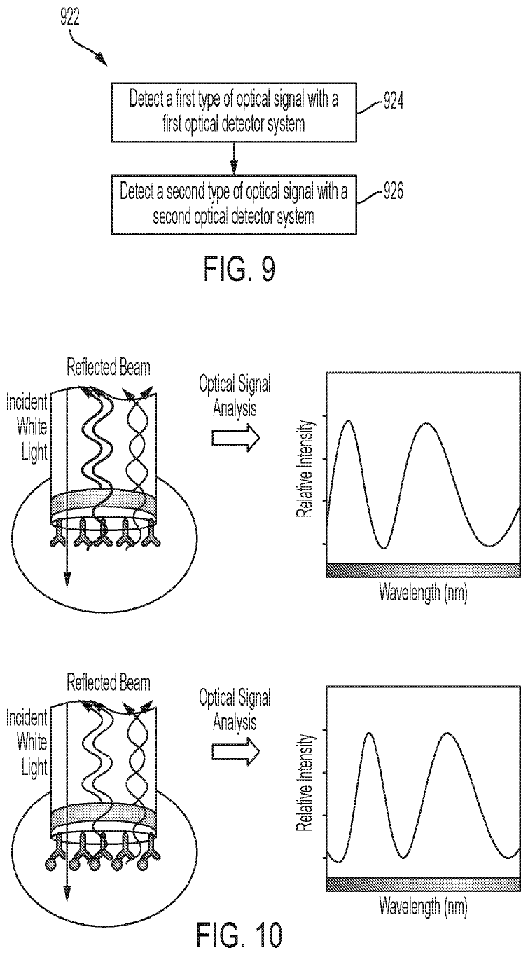

Some embodiments relate to methods. As noted above, some methods described herein may be capable of being performed in the instruments described herein and some instruments described herein may be capable of performing and/or configured to perform some of the methods described herein. One exemplary method is shown in FIG. 9. FIG. 9 shows the method 922, in which a first type of optical signal is detected with a first optical detector system (step 924) and a second type of optical signal is detected with a second optical detector system (step 926). Although FIG. 9 shows an arrow connecting step 924 to step 926, these steps may be performed in any order. For instance, step 924 may be performed before step 926, after step 926, and/or over a period of time that partially or completely overlaps with the period of time over which step 926 is performed. Similarly, step 926 may be performed before step 924, after step 924, and/or over a period of time that partially or completely overlaps with the period of time over which step 924 is performed. In other words, the first and second types of optical signals may be detected serially (e.g., the first type of optical signal may be detected before the second type of optical signal, the second type of optical signal may be detected before the first type of optical signal), simultaneously (e.g., the first and second types of optical signals may be detected in a common period of time), and/or both. It is also possible for a method to comprise detecting three or more types of optical signals.

The first and second types of optical signals may differ from each other in one or more ways. For instance, they may comprise different types of light. As another example, one optical signal may comprise the presence of one type of light and another optical signal may comprise the absence of a type of light.

Different types of optical signals may be detected when one or more probes are positioned in a variety of locations. As one example, in some embodiments, a first type of optical signal is detected when a probe (e.g., a first probe) is in contact with a fluid. Similarly, a second type of optical signal may be detected when a probe (e.g., the first probe, a second probe) is in contact with a fluid. Further types of optical signals (e.g., third types of optical signals) may also be detected when a probe (e.g., a first probe, a second probe, a third probe) is in contact with a fluid. In some embodiments, two or more types of optical signals (e.g., first and second types of optical signals) are detected when a probe (e.g., a first probe) is in contact with a single fluid (i.e., the first and second optical signals are detected when a probe is in contact with the same fluid). It is also possible for two or more types of optical signals (e.g., first and second types of optical signals) to be detected when a probe (e.g., a first probe) is in contact with different fluids. In such embodiments, a first type of optical signal may be detected when the probe (e.g., a first probe) is in contact with a first fluid and, before or after such detection, a second type of optical signal may be detected when the probe is in contact with a second fluid. Similarly, in some embodiments, two or more types of optical signals (e.g., first and second types of optical signals) may be detected when two or more probes are in contact with different fluids. In such embodiments, the two types of optical signals may be detected serially and/or simultaneously.

Different types of optical signals may be detected during the performance of a single assay (e.g., two or more types of optical signals may be detected as part of the same assay) and/or different types of optical signals may be detected as part of different assays. In the latter scenario, such assays may be performed (and optical signals may be detected) simultaneously and/or serially.

As described above, in some embodiments, an instrument is capable of detecting and/or configured to detect one or more optical signals. Similarly, some methods comprise detecting one or more optical signals. Such an optical signal may be indicative of the presence, absence, and/or amount of a species immobilized on a probe. It is also possible for an optical signal to be indicative of the presence, absence, and/or amount of a species generated from a species immobilized on a probe. In some embodiments, an optical signal is indicative of a feature of a sample being analyzed and/or assayed (e.g., the presence, concentration, or absence of one or more components therein), indicative of a feature of a standard present in an assay (e.g., the presence, concentration, or absence of one or more components therein), a reference signal, a background signal, and/or a baseline signal.

An optical signal may comprise the presence or absence of light of a variety of wavelengths and/or polarizations. In some embodiments, the light may comprise visible light. It is also possible for the light to comprise infrared light. Additionally, the light may be polarized light or unpolarized light.

Optical signals may arise from a variety of locations in a fluid (e.g., a fluid with which a probe is and/or was in contact) and/or a solid (e.g., a solid surface of a probe, a solid surface of a layer disposed on a probe, a solid surface of a container of a fluid with which a probe is and/or was in contact). For instance, some optical signals may arise from a surface of a fluid or solid (e.g., an upper surface, a lower surface, a side surface). As another example, some optical signals may arise from an interior of a fluid or solid. In some embodiments, an optical signal arises from the entirety of the fluid or solid.

Optical signals may comprise light and/or the absence of light. In some embodiments, an instrument is configured to detect an optical signal comprising both light reflected from an interface internal to a probe and light that has been reflected from the end of the probe. Such an optical signal may comprise both types of light, light interference between these two types of light (e.g., interference between light supplied by a common light source but traveling through optical pathways having different optical path lengths), the absence of either or both such type of light, and/or the absence of such interference. As two examples, optical signals may comprise interference between light that is reflected from two different interfaces associated with a probe and/or a species immobilized on a probe (e.g., an interface between an interior portion of a probe and a coating disposed on the internal portion of the probe, an interface between the species and the probe, an interface between the species and an environment external to the probe, an interface at the end of the probe) or the absence of such interference.

Light that is reflected from an interface may be supplied to a probe from a light source system. As described elsewhere herein, a light source system may be optically coupled to a probe such that light is transmitted from the light source system and across the probe (e.g., parallel to an optical axis of the probe). Upon reaching an end of the probe, the light may be transmitted out of the probe and/or may reflect from an interface between the probe and an environment external to the probe (and/or from the end of the probe). If there is a species immobilized on the probe, some light may reflect from the interface between the probe and the species and/or some light may be transmitted through the species. The species may also change the effective refractive index at the end of the probe and/or change the effective optical path length of the light transmitted through the probe. Light transmitted through the species will then encounter the environment with which the species is in contact (e.g., a fluid contacting the probe). Some light encountering this environment may be transmitted into the environment with which the species is in contact (e.g., an environment external to the probe) and/or may reflect from the interface between the environment and the species.

It is also possible for probe described herein to have one or more internal interfaces at which reflection may occur. For instance, some probes may comprise one or more internal interfaces at which reflection can occur, such as an interface between a coating and an interior portion of the probe on which the coating is disposed.

Light reflected from one or more of the above-described locations (and/or any further locations) may travel back through the probe. If light is reflected from multiple locations (e.g., at an interface between the probe and a species immobilized on the probe, at an interface between a species immobilized on the probe and an environment external to the probe, at an interface between a coating disposed on an interior portion of the probe and a species immobilized on the probe, at an interface between an interior portion of the probe and a coating disposed thereon, from the end of the probe), such light may interfere which each other. Light interference may cause the intensity of the interfered light to be higher or lower depending on whether the interference is positive or negative, which may depend on the phase shift between the multiple sources of interfering light. The phase shift may depend on the differences in the path lengths traveled by the light prior to interfering, the refractive index of the material(s) through which the light passes prior to interfering, and/or on the wavelength of light. Accordingly, obtaining information about the intensity of interfered light across a variety of wavelengths may provide information about the presence or absence of a layer comprising a species immobilized on a probe, the thickness of such a layer, and/or the refractive index of such a layer. This information may be employed to determine the presence, absence, and/or amount of the species immobilized on the probe.

FIG. 10 depicts schematically one example of a process by which an optical signal comprising both an amount of the light that has been reflected from an interface internal to a probe and an amount of light that has been reflected from the end of a first probe can be generated. As shown in FIG. 10, light that travels down a probe may reflect from an interface between a coating disposed on an interior portion of a probe and from an interface between a species immobilized on the probe and an environment external to the probe. The phase shift between these two sources of reflected light may depend on the amount of analyte immobilized on the probe and on the wavelength of the reflected light, which may affect the intensity of the reflected light measured. Analysis of the intensity of the reflected light as a function of wavelength may therefore be employed to determine an amount of analyte immobilized on the probe.

Other examples of optical signals that may be detected include optical signals comprising light that has been emitted, transmitted, reflected, scattered, and/or polarized. As an example, an optical signal may comprise light that has been emitted, transmitted, reflected, scattered, and/or polarized by a species immobilized on a probe. As another example, an optical signal may comprise light that that has been emitted, transmitted, reflected, scattered, and/or polarized by a species that is generated from a species immobilized on a probe. Emitted light may comprise light that has been emitted by fluorescence (e.g., fluorescence stimulated by light transmitted through the probe, such as light emitted by a light source system), luminescence (e.g., chemiluminescence), and/or scattering (e.g., Raman scattering).

It is also possible for an optical signal to comprise the absence of light that has been absorbed. Light that is absent, and forms an optical signal, may comprise light that has been absorbed or reflected. It may be perceived as a change in color of the light impinging on the relevant fluid. As an example, an optical signal may comprise light that has been absorbed by a species immobilized on a probe and/or a species that is generated from a species immobilized on a probe. For instance, a species immobilized on a probe may react with a species present in a fluid with which it is in contact to generate a species that absorbs light, and the optical signal may comprise the absence of light absorbed by such a species.

In some embodiments, the presence, intensity, and/or polarization of light may convey information about a sample and/or an assay being performed. For instance, some samples may comprise a species that emits, reflects, transmits, scatters, and/or polarizes light. As another example, some assays may result in the generation of light at a particular wavelength, within a particular wavelength range, at a particular combination of wavelengths, and/or having a particular polarization. The detection of such light may indicate that an assay was performed correctly, that a sample being assayed has a particular feature, that a sample comprises a particular component, and/or that a sample comprises a particular component in a particular amount. The absence of such light may indicate that an assay was performed incorrectly, that a sample being assayed lacks a particular feature, and/or that a sample lacks a particular component.

In some embodiments, the absence of light may convey information about a sample and/or an assay being performed. The sample may comprise a species that absorbs light at a particular wavelength, within a particular wavelength range, and/or at a particular combination of wavelengths. In some embodiments, an assay results in the generation of a species that absorbs light at a particular wavelength, within a particular wavelength range, and/or at a particular combination of wavelengths. The absence of such light may indicate that an assay was performed correctly, that a sample being assayed has a particular feature, that a sample comprises a particular component, and/or that a sample comprises a particular component in a particular amount. The presence of such light may indicate that an assay was performed incorrectly, that a sample being assayed lacks a particular feature, and/or that a sample lacks a particular component.

In some embodiments, an instrument is configured to detect and/or capable of detecting two types of optical signals. Similarly, some methods comprise detecting two types of optical signals. In some such embodiments, one type of optical signal comprises an amount of light that has been reflected from an interface internal to a probe and an amount of light that has been reflected from the end of probe and another type of optical signal may comprise a different type of optical signal. For instance, the other type of optical signal may comprise light that has been transmitted, reflected, scattered, polarized, and/or emitted from a species immobilized on a probe and/or from a species generated from a species immobilized on a probe. As another example, the other type of optical signal may comprise the absence of an amount of light that has been absorbed by a species immobilized on a probe and/or absorbed by a species generated from a species immobilized on a probe.

Without wishing to be bound by any particular theory, detecting both of the above-described types of optical signals together may be particularly advantageous. The former type of optical signal may be well-suited for quickly determining whether a fluid includes a particular species and/or for performing kinetic measurements. The latter type of optical signal may be well-suited for quantifying the amount of a particular species in a fluid. Accordingly, the two types of optical signals may provide complementary information.

As another example, the two types of optical signals described above may be capable of being detected from a common fluid and/or a container thereof. As described above, the former type of optical signal may depend strongly on the presence, absence, and/or amount of immobilization of the species on a probe and may be relatively insensitive to one or more features of a fluid with which a probe is and/or was in contact. By contrast, the latter type of optical signal may arise from the bulk of such fluids. In some embodiments, the latter type of optical signal is relatively insensitive to the presence of any species immobilized on a probe (e.g., when the optical signal arises from species present in a fluid, when any species immobilized on the probe transmits substantially all of the light incident upon it). However, it is also possible for the latter type of optical signal to be sensitive to such species.

It is also possible for the two types of optical signals described to provide complementary information about a species immobilized on a probe (e.g., the first type of optical signal may provide information about the presence, absence, and/or amount of such a species while the second type of optical signal provides information about a quality of such a species arising from its transmission, scattering, polarization, and/or absorption of light).

In some embodiments, a first type of optical signal comprises an amount of the first type of light that has been reflected from an interface internal to a first probe and an amount of the first type of light that has been reflected from the end of the first probe, and a second type of optical signal comprises the absence of an amount of a second type of light that has been absorbed by a species. The species may be immobilized on a probe and/or generated from a species immobilized on a probe. In some embodiments, a first type of optical signal comprises an amount of the first type of light that has been reflected from an interface internal to a first probe and an amount of the first type of light that has been reflected from the end of the first probe, and a second type of optical signal comprises a second type of light that has been emitted from a species. The species may be immobilized on a probe and/or generated from a species immobilized on a probe. The emission may be via fluorescence and/or luminescence (e.g., chemiluminescence). In some embodiments, a first type of optical signal comprises an amount of the first type of light that has been reflected from an interface internal to a first probe and an amount of the first type of light that has been reflected from the end of the first probe, and a second type of optical signal comprises an amount of a second type of light that has been scattered by a species. The species may be immobilized on a probe and/or generated from a species immobilized on a probe.

It is also possible for an instrument to be configured to detect and/or capable of detecting three or more types of optical signals and/or for a method to comprise detecting three or more types of optical signals. In such embodiments, the three or more optical signals may comprise some or all of the optical signals described elsewhere herein. For instance, an instrument may be configured to detect one type of optical signal that comprises an amount of light that has been reflected from an interface internal to a probe and an amount of light that has been reflected from the end of probe and two or more further types of optical signals. These further types of optical signals may comprise light that has been emitted (e.g., via luminescence, via fluorescence) and/or the absence of light that has been absorbed. The species emitting or absorbing the light may be species immobilized on a probe and/or species generated from a species immobilized on a probe.

Detection of an optical signal may be performed at one or more discrete points in time or over a period of time. Additionally, such detection may be performed in a manner that yields a single data point (e.g., an endpoint, the average intensity of light at a particular wavelength as measured over a period of time, the average intensity of light at a particular wavelength as computed by averaging a plurality of measurements of light intensity, the intensity of light at a particular wavelength as determined from a single measurement) and/or a plurality of data points. The plurality of data points may describe the variation of the optical signal over time (e.g., in a kinetic measurement, in a time-resolved fluorescence measurement), the variation of the optical signal as a function of position (e.g., across multiple positions in a single fluid, such as a single sample or a single standard), and/or the variation of the optical signal as a function of wavelength. The plurality of data points may be obtained from different measurements that take place over different (overlapping or non-overlapping) periods of time. When an optical signal is detected over a period of time, the period of time over which the optical signal is detected may be the same period of time over which a probe is contacted with a fluid or may be a different period of time (e.g., a subset of that period of time). It is also possible for the period of time to be a period of time over which a species is removed from the probe (e.g., during a refunctionalization step).

In some embodiments, detecting an optical signal over time comprises detecting its variation over time. The variation may comprise an increase, a decrease, or a lack of variation. In some embodiments, the variation comprises the first derivative of the optical signal. The variation in an optical signal over a period of time may be determined from multiple measurements made on a single optical signal over the period of time that yield multiple values of the optical signal over the period of time. The period of time over which the optical signal is measured may comprise a variety of suitable points in time during analyte immobilization on a probe and/or analyte removal from the probe. For instance, the variation may be measured upon initial contact of the probe with a fluid and/or a sample of a fluid, upon initial removal of contact between the probe and a fluid, when the amount of a species immobilized on the probe is at one or more particular percentages of the amount of the species that would be immobilized on the probe at steady state, when the amount of the species immobilized on the probe is the steady-state value, or at any time in between.

As another example, in some embodiments, a variation in an optical signal comprises the decay in intensity of emitted fluorescent light. In such embodiments, the period of time over which the optical signal is measured may comprise a variety of suitable points in time during and/or after the stimulation of fluorescent emission, such as during the irradiation of a probe and/or a fluid with stimulating light and/or thereafter. For instance, in time-resolved fluorescence measurements, light taking the form of a short excitation pulse may be employed to stimulate the emission of fluorescent light, the intensity of which may be measured subsequent to the excitation pulse.

The point in time at which the variation of the optical signal is measured may be selected as desired. In some embodiments, the variation of the optical signal is measured when the amount of a species immobilized on the probe is greater than or equal to 0%, greater than or equal to 5%, greater than or equal to 10%, greater than or equal to 15%, greater than or equal to 20%, greater than or equal to 25%, greater than or equal to 30%, greater than or equal to 35%, greater than or equal to 40%, or greater than or equal to 45% of the amount of the species that would be immobilized on the probe at steady state. In some embodiments, the variation of the optical signal is measured when the amount of a species immobilized on the probe is less than or equal to 50%, less than or equal to 45%, less than or equal to 40%, less than or equal to 35%, less than or equal to 30%, less than or equal to 25%, less than or equal to 20%, less than or equal to 15%, less than or equal to 10%, or less than or equal to 5% of the amount of the species that would be immobilized on the probe at steady state. Combinations of the above-referenced ranges are also possible (e.g., greater than or equal to 0% and less than or equal to 50%, greater than or equal to 0% and less than or equal to 10%, or greater than or equal to 0% and less than or equal to 5%). Other ranges are also possible.

The value of an optical signal may be indicative of an amount and/or a type of species immobilized on a probe. At equilibrium, the amount of the species immobilized on a probe may be indicative of its affinity for the probe and/or another species immobilized on the probe. Additionally, in some instances, the variation of an optical signal over time may be indicative of a rate at which a species becomes immobilized on a probe. The rate at which the species becomes immobilized on the probe may depend on the amount of analyte in the fluid to which the probe is exposed and/or the interaction between the species and the probe. As an example of the latter, the rate at which a species becomes immobilized on the probe may depend on the affinity of the species for the probe (and/or its surface chemistry and/or another species immobilized on the probe) and/or the rate at which the species binds to the probe (and/or its surface chemistry and/or another species immobilized on the probe). As another example of the latter, the rate at which a species is removed from the probe upon contact with a fluid other than that comprising the species (e.g., a different fluid, a refunctionalization fluid) may also be indicative of the affinity of the species for the probe (and/or its surface chemistry and/or another species immobilized on the probe) and/or the rate at which an analyte binds to the probe (and/or its surface chemistry and/or another species immobilized on the probe). Accordingly, the methods described herein may be suitable for determining the affinity of a species for a probe and/or another species immobilized on a probe. The affinity of a species for a probe may be parametrized by its association constant and/or its dissociation constant, as described in further detail below.

Without wishing to be bound by any particular theory, it is believed that any particular species may bind most rapidly to the probe upon initial contact between the fluid comprising the species (and/or a sample thereof) and the probe. Accordingly, it is also believed that measuring a variation in an optical signal may yield information that is more precise and/or may yield information more rapidly when the period of time over which the variation is measured comprises the initial contact between the fluid and the probe.

Variation in the optical signal may be indicative of changes in the amount of a species immobilized on a probe, which itself may be indicative of a measurement that is made before the amount of the species immobilized on the probe achieves a steady-state value. In this scenario, the rate at which the species immobilized on the probe approaches its steady-state value may vary with the concentration of the species in a fluid with which the probe is contacted, and so may be employed to assess the concentration of the species in that fluid. In some embodiments, the variation of the rate at which the species immobilized on the probe approaches its steady-state value varies more than the amount of the species immobilized on the probe at steady state. Accordingly, in some embodiments, measuring the rate at which a species becomes immobilized on a probe may provide a way to determine a concentration of the species that is more sensitive and/or more rapid than measuring an amount of the species immobilized on a probe at a final steady-state value.

In some embodiments, an optical signal that is detected is compared to a model signal profile. The model signal profile may be the model signal profile associated with a desired and/or expected outcome (e.g., an expected signal profile associated with the presence of a species in a fluid contacting a probe) or an undesired and/or unexpected outcome (e.g., instrument malfunction). Comparing an optical signal to a model signal profile may be employed to assess whether the instrument and/or probe is functioning in a normal manner. As an example, if an optical signal does not match a model signal profile associated with an expected outcome, it may indicate an instrument malfunction. On the other hand, if an optical signal does match such a model signal profile, it may indicate that the instrument is functioning normally. As another example, if an optical signal matches a model signal profile associated with an instrument malfunction, it may indicate the presence of such malfunction.

A variety of suitable optical detector systems may be present in the instruments described herein. In some embodiments, an optical detector system may comprise an optical detector. Non-limiting examples of suitable types of optical detectors include photon-counting devices (e.g., gated photon counters), spectrophotometers, spectrometers (e.g., Raman spectrometers, infrared spectrometers), polarization detectors, photodiodes, photodiode arrays, avalanche photodiodes, CMOS sensors, CCD sensors, CCD/CMOS sensors, imaging sensors, photomultiplier tubes (and, in some embodiments, associated controllers), and microchannel plate detectors. In some embodiments, an optical detector is part of a plate reader.

In some embodiments, an instrument comprises a first optical detector system that is capable of detecting and/or configured to detect a first type of optical signal and a second optical detector system that is capable of detecting and/or configured to detect a second type of optical signal. In such embodiments, the first and second optical detector systems may be the same or they may differ in one or more ways. As an example, in some embodiments, a first optical detector system comprises a first optical detector and a second optical detector system comprises a second optical detector that differs from the first optical detector in one or more ways. In such embodiments, the first optical detector may be particularly well-suited to detecting the first type of optical signal and the second optical detector may be particularly well-suited to detecting the second type of optical signal. It is also possible for an instrument to comprise three or more optical detector systems. Such optical detector systems may each differ from each other in one or more ways and/or be capable of and/or configured to detect different types of optical signals. Optical detectors that are particularly well-suited to detecting an optical signal that comprises an amount of light that has been reflected from an interface internal to a probe and an amount of light that has been reflected from the end of probe include spectrometers. Such light may comprise light at a variety of wavelengths, and the relative amounts of different wavelengths of light may be informative regarding the interference between these two types of light (e.g., wavelengths for which there is constructive interference may be present at higher intensities than wavelengths for which there is destructive interference). Spectrometers may be capable of detecting light intensity at a variety of wavelengths simultaneously and in a differentiated manner, and so may be well-suited for such optical signals.

Optical detectors that are particularly well-suited to detecting optical signals comprising light emitted by a species (e.g., immobilized on a probe, generated from a species immobilized on a probe) include photomultipliers and microchannel plate detectors. Such optical detectors may have a sufficiently high quantum efficiency and rate of response to be suitable for detecting this type of light.

Optical detectors that are particularly well-suited to detecting optical signals comprising the absence of light absorbed by a species (e.g., immobilized on a probe, generated from a species immobilized on a probe) include photodiodes and photodiode arrays.

The optical detectors described herein may be configured to detect and/or capable of detecting a variation of an optical signal over one or more periods of time. For instance, such optical detectors may be able to make relatively rapid measurements of an optical signal and/or measure an optical signal over a relatively short period of time. The detection of the variation of an optical signal over time may be facilitated by the presence of, e.g., a delay generator (e.g., a digital delay generator). It is also possible for some optical detectors to be configured to detect and/or capable of detecting a plurality of optical signals (e.g., a plurality of optical signals, each associated with a different measurement, such as a fluid and/or a different time point).

In some embodiments, an optical detector system further comprises one or more additional components. For instance, an optical detector system may further comprise an optical cable. An optical cable may be capable of transmitting and/or configured to transmit light from a location at which it is generated and/or detectable to an optical detector. In some embodiments, the location from which an optical cable is capable of transmitting light is a probe. Light that is transmitted through the probe may be transmitted from the probe to the optical cable, through the optical cable, and to an optical detector. In some embodiments, the location from which an optical cable is capable of transmitting light is a location other than a probe. As one example, an optical cable may be positioned proximal to a fluid (e.g., a fluid with which a probe is in contact, was in contact, and/or will be in contact). Such optical cables, when positioned opposite such fluids from probes, may be capable of transmitting and/or configured to transmit light transmitted from the probe and through the fluid to an optical detector.

In some embodiments, an optical detector system further comprises wavelength selector. Wavelength selectors may be capable of transmitting and/or configured to transmit some wavelengths of light at higher intensities than others. Some wavelength selectors may be capable of transmitting and/or configured to transmit negligible or no light at certain wavelengths. Without wishing to be bound by any particular theory, the presence of wavelength selectors in an optical detector system may advantageously enhance the detection of some wavelengths of light that are present at a relatively low intensity in comparison to other wavelengths of light also present. For instance, a wavelength selector may be present that is capable of transmitting and/or configured to transmit a relatively low amount of light supplied to stimulate fluorescent emission while being capable of transmitting and/or configured to transmit a relatively high amount of fluorescently emitted light.

Wavelength selectors may be provided at a variety of suitable locations in optical detector systems. Non-limiting examples of such locations include locations between a probe and an optical cable, between a fluid (e.g., a fluid with which a probe is in contact, was in contact, and/or will be in contact) and an optical cable, and between an optical cable and an optical detector.

Non-limiting examples of suitable wavelength selectors include filters, diffraction gratings, and prisms. In some embodiments, an optical detector system comprises a wavelength selector that is a filter wheel, such as a motorized emission filter wheel (e.g., that may be multichannel). In some embodiments, a wavelength selector is provided in conjunction with a bandwidth selector. The bandwidth selector may be capable of selecting and/or configured to select the size of the range of wavelengths to be transmitted through the wavelength selector. For wavelength selectors that have dispersion elements, the wavelength selector may take the form of an aperture or a slit that transmits light within a particular wavelength range. The width of the aperture or slit may be selected as desired considering the intensity of the light to be transmitted, sensitivity desired, and the closeness in wavelengths between the light desired to be transmitted and the light desired to not be transmitted.

As noted above, in some embodiments, an optical detector system comprises a delay generator, such as a digital delay generator. This component may be particularly suitable for performing a time-resolved fluorescence measurement (e.g., on an optical signal that comprises fluorescent light).

The optical detector systems described herein may also be capable of detecting and/or configured to detect light at a single polarization and/or at a plurality of polarizations. When a light source is capable of detecting and/or configured to detect light at a plurality of polarizations, the optical detector system may further comprise one or more polarizing filters. Such polarizing filter(s) may be positioned between a probe and an optical cable, between a fluid (e.g., a fluid with which a probe is in contact, was in contact, and/or will be in contact) and an optical cable, and between an optical cable and an optical detector. Polarizing filters may be beneficial if the optical signal comprises light polarized by a species immobilized on a probe and/or a species generated from a species immobilized on a probe.

Optical detector systems may be configured to receive light and/or capable of receiving light generated at a variety of locations. In some embodiments, an optical detector system is positioned proximal to a probe and/or a probe handling system. In such embodiments, the optical detector system may be capable of receiving and/or configured to receive light transmitted through the probe. It is also possible for an optical detector system to be positioned distal to a probe and/or a probe handling system. In such embodiments, the optical detector system may be capable of receiving and/or configured to receive light from a location at which an optical signal is generated. For instance, in some embodiments, an optical cable may transmit light (e.g., light that is an optical signal, light that indicates the absence of an optical signal) from a location proximal to the location at which the optical signal is generated to the optical detector. Without wishing to be bound by any particular theory, it is believed that optical detector systems capable of receiving light from and/or configured to receive light from a location positioned on an opposite side of a support structure from a probe may be particularly suitable for detecting optical signals comprising the absence of light (e.g., due to absorption, reflection, and/or scattering). Similarly, and also without wishing to be bound by any particular theory, it is believed that optical detector systems having such designs may also be particularly suitable for detecting optical signals comprising transmitted light.

A variety of suitable light source systems may be present in the instruments described herein. In some embodiments, a light source system may comprise a light source. Non-limiting examples of suitable types of light sources include incandescent bulbs and/or lamps (e.g., xenon flash lamps, tungsten halogen lamps, mercury lamps, arc lamps), LEDs, and laser diodes. In some embodiments, a light source system comprises a light source that is part of a plate reader. In some such embodiments, both the light source system and the optical detector system are part of a common plate reader. For instance, an instrument may comprise a plate reader that comprises both a light source (and/or light source system) and an optical detector (and/or optical detector system).

In some embodiments, an instrument comprises a first light source system that is capable of emitting and/or configured to emit a first type of optical signal and a second light source system that is capable of emitting and/or configured to emit a second type of light. In such embodiments, the first and second light source systems may be the same or they may differ in one or more ways. As an example, in some embodiments, a first light source system comprises a first light source and a second light source system comprises a second light source that differs from the first light source in one or more ways. In such embodiments, the first light source may be particularly well-suited to emitting a type of light suitable for generating the first type of optical signal and the second light source system may be particularly well-suited to emitting a type of light suitable for generating the second type of optical signal. It is also possible for an instrument to comprise three or more light source systems. Such light source systems may each differ from each other in one or more ways and/or be capable of and/or configured to emit different types of light.

Light sources that are particularly well-suited to emitting light that is well-suited for generating a signal that comprises an amount of light that has been reflected from an interface internal to a probe and an amount of light that has been reflected from the end of probe include those that emit white light and/or light at a variety of wavelengths.

Light sources that are particularly well-suited to emitting light that is well-suited for generating a signal that comprises light emitted by a species (e.g., immobilized on a probe, generated from a species immobilized on a probe) include those that are capable of emitting light and/or are configured to emit light with a high intensity at one or more wavelengths that stimulate the species to emit light. Some such light sources may also be capable of emitting and/or configured to emit a relatively low (or zero) amount of light at one or more wavelengths at which the species emits light.

Similarly, light sources that are particularly well-suited to emitting light that is well-suited for generating a signal that comprises the absence of light absorbed by a species (e.g., immobilized on a probe, generated from a species immobilized on a probe) include light sources that emit light with a high intensity at one or more wavelengths at which the species absorbs light. Some such light sources may also be capable of emitting and/or configured to emit a relatively low (or zero) amount of light at one or more wavelengths at which the species transmits light.

Light sources that are particularly well-suited to emitting light that is well-suited for generating a signal that comprises light polarized by a species (e.g., immobilized on a probe, generated from a species immobilized on a probe) include light sources that emit light with a particular polarization or that is unpolarized. Some such light sources may also be capable of emitting and/or configured to emit a relatively low (or zero) amount of light at one or more polarizations at which the species polarizes light.

It is also possible for two light source systems to share a common light source. Such light sources may be part of both light source systems or part of neither light source system. In embodiments in which two light source systems share a common light source, one or more of the light source system may comprise a wavelength selector (as described in further detail below). In such embodiments, the light source systems may comprise and/or interface with a light source that emits white light and/or light at a plurality of wavelengths. All or a substantial fraction of the wavelengths of the white light may be transmitted through and ultimately emitted from one of the light source systems while a more limited fraction of the wavelengths may be transmitted through and ultimately emitted from the other light source system.

In some embodiments, a light source system further comprises one or more additional components. For instance, a light source system may further comprise an optical cable. An optical cable may be capable of transmitting and/or configured to transmit light from a light source to a location at which an optical signal is generated. In some embodiments, the location to which an optical cable is capable of transmitting light is a probe. Light that is transmitted to the probe may be transmitted from the light source to the optical cable, through the optical cable, and to the probe.

In some embodiments, an optical cable is capable of transmitting light to a location other than a probe. For instance, an optical cable may be capable of transmitting light from a light source to an internal reference. In some embodiments, an instrument comprises two optical cables capable of transmitting light to two different internal references (e.g., a positive control and a negative control). The internal reference may comprise an optical detector (e.g., a photodiode) to detect one or more features of the light (e.g., intensity). In some embodiments, the feature(s) detected by the optical detector positioned in the internal reference may be employed to perform a correction on an optical signal detected by the instrument. As an example, the feature(s) detected may be employed to correct for light intensity fluctuations, optical detector sensitivity, optical detector drift, light source intensity, volume from which an optical signal is generated (e.g., volume that is illuminated by light transmitted through the probe), and/or wavelength selector efficiency. It is also possible for the feature(s) detected by the optical detector positioned in the internal reference to be employed to calibrate one or more components of the instrument (e.g., a photomultiplier tube positioned in an optical detector system).

In some embodiments, a light source system further comprises a wavelength selector. Such wavelength selectors may be the same as those described above with respect to optical detector systems. In some embodiments, a light source system comprises a wavelength selector that is a filter wheel, such as a motorized excitation filter wheel (e.g., that may be multichannel). Wavelength selectors may be provided at a variety of suitable locations in light source systems. Non-limiting examples of such locations include locations between a probe and an optical cable and between an optical cable and a light source. Wavelength selectors may be beneficial when the light emitted by the light source comprises at least one wavelength that would overlap with the wavelength of an optical signal to be detected and/or if the light emitted by the light source comprises at least one wavelength that would stimulate the generation of an optical signal independently of whether the assay would yield a positive or negative result (e.g., in the case where light at the relevant wavelength would stimulate emission from a variety of species, including a species that would always be immobilized on a probe and/or present in a fluid contacting a probe).

The light source systems described herein may also supply light at a single polarization and/or at a plurality of polarizations. When a light source supplies light at a plurality of polarizations, the light source system may further comprise one or more polarizing filters. Such polarizing filter(s) may be positioned between the light source and an optical cable and/or between an optical cable and a probe. Polarizing filters may be beneficial if the light emitted by the light source comprises light at a wavelength and polarization that would overlap with the wavelength and polarization of the optical signal and/or if the light emitted by the light source comprises at least one polarization that would stimulate the generation of an optical signal independently of whether the assay would yield a positive or negative result (e.g., in the case where light at the relevant polarization would stimulate emission from a variety of species, including a species that would always be immobilized on the probe and/or present in a fluid contacting the probe).

In some embodiments, a light source system further comprises a lens. The lens may focus the light prior to its transmission through a probe.

In some embodiments, an instrument is capable of operating and/or configured to operate in conjunction with one or more probes. Such probes may have a variety of suitable designs. In some embodiments, an instrument is capable of operating and/or configured to operate in conjunction with two probes that differ from each other in one or more ways. As one example, an instrument may be capable of operating and/or configured to operate in conjunction with a first probe suitable for transmitting a first type of optical signal and/or a first type of light (e.g., light suitable for generating a first type of optical signal) and also be capable of operating and/or configured to operate in conjunction with a second probe suitable for transmitting a second type of optical signal and/or a second type of light (e.g., light suitable for generating a second type of optical signal). It is also possible for an instrument to be capable of operating and/or configured to operate in conjunction with at least one probe that is suitable for transmitting more than one type of optical signal and/or more than one type of light (e.g., light suitable for generating more than one type of optical signal). In some embodiments, an instrument is capable of operating and/or configured to operate in conjunction with three or more probes. Such probes may each differ from each other in one or more ways and/or be suitable for transmitting different types of optical signals and/or light.

Some probes suitable for use with the instruments described herein are optical probes. Such probes may be part of one or more optical pathways present in the instruments (e.g., between a light source system and a fluid with which the probe is in contact, between an optical detector system and a fluid with which the probe is in contact) and/or may be configured to transmit light. In some embodiments, a probe is transparent to and/or may transmit light at a plurality of wavelengths (e.g., visible wavelengths, infrared wavelengths, near infrared wavelengths, wavelengths of light emitted by a light source system, wavelengths of light that an optical detector system is capable of detecting and/or configured to detect). Some probes comprise one or more polished ends to facilitate transmission. Such polished ends may be perpendicular to the optical axis of the probe.

Probes may have a variety of suitable designs. In some embodiments, a probe is a fiber-optic probe and/or comprises an optical fiber. It is also possible for a probe to include two or more optical fibers. For instance, a probe may comprise a fiber-optic bundle. In some embodiments, a probe comprises one or more apertures through which light may be transmitted. For instance, a probe may comprise a plurality of optical fibers, and the terminus of each optical fiber may serve as an aperture through which light may be transmitted. When present, the apertures may be positioned on a side of the probe opposite a side on which any optical detector systems and/or light source systems are positioned. In such embodiments, the probe may serve to transmit light from a light source system to an aperture and/or to transmit light from an aperture to an optical detector system.

It is also possible for a probe to comprise further optics (e.g., in addition to optical fibers) that assist with the transmission of light. As an example, a probe may comprise a lens and/or a pinhole. When present, these components may assist with near-field imaging. In some embodiments, a probe comprises a lens that is configured to collect and transmit light to the probe and/or a component thereof. As an example, the lens may be configured to collect and transmit light to an axis along the center and/or optical axis of the probe, along the center and/or optical axis of an optical fiber present in the probe, and/or along the center and/or optical axis of a fiberoptic bundle present in the probe.

In some embodiments, a probe comprises one or more components that allow it to be optically coupled to a light source system, an optical detector system, and/or a component thereof (e.g., an optical cable). As an example, in some embodiments, a probe comprises a component, such as a plastic hub, that is compatible with an SMA connector (e.g., an SMA905 connector), a BNC connector, a connector with push, lock, and/or twist functionality, and/or a compression spring. In some embodiments, a probe is coupled to an optical cable via a ferrule. The ferrule may comprise optical fibers comprising polished tips, which may facilitate optical communication with the probe. In some embodiments, a probe is capable of being and/or configured to be optically coupled to an optical cable that comprises one or more components to assist with strain relief at the location of the coupling.

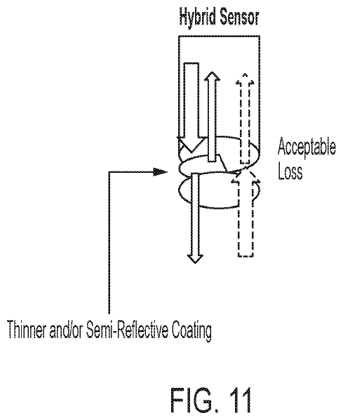

In some embodiments, a probe comprises an interface internal thereto. As described above, such probes may be particularly suitable for generating optical signals comprising an amount of light that has been reflected from this interface and an amount of type of light that has been reflected from the end of the probe. When present, such interfaces may extend across the entirety of a probe cross-section (e.g., the cross-section perpendicular to the axis along which light is transmitted through the probe, the cross-section perpendicular to the long axis of the probe) or may extend through only a portion of the probe cross-section. In the latter embodiments, a portion of the probe cross-section lacks an interface internal to the probe. Such probes may be particularly suitable for transmitting light that assists with the generation both of the type of optical signal described in this paragraph and of the types of optical signals described in the following paragraph. The light transmitted for assisting with the type of optical signal described in this paragraph may reflect at the internal interface, and the light transmitted for assisting with the types of optical signals described in the following paragraph may be transmitted through the optical probe without appreciable reflection at any interfaces internal thereto. This is shown schematically in FIG. 11, which shows that some portion of light transmitted from a light source system to the probe may impinge on the internal interface (and some portion of that light may reflect at the internal interface) and another portion of this light may pass through the probe without so impinging. This may allow for enough reflection from the internal interface to allow for the generation of the type of optical signal described in this paragraph with a sufficiently low loss of light to allow for generation of a type of optical signal generated in the following paragraph. It is also possible for a probe having an internal interface that extends across the entirety of its cross-section to have this property if a coating to which the internal interface is adjacent is sufficiently thin and/or semi-reflective.

In some embodiments, a probe lacks any interfaces internal thereto. In such embodiments, the probe may have a uniform composition throughout the probe and/or may lack composition and/or morphological variation that would cause appreciable reflection and/or scattering of light. Such probes may be particularly suitable for transmitting light that causes the generation of one or more of the following types of optical signals: light that has been emitted, transmitted, reflected, scattered, and/or polarized from a species immobilized on the probe; light that has been emitted, transmitted, reflected, scattered, and/or polarized from a species generated from a species immobilized on the probe; the absence of light that has been absorbed by a species immobilized on the probe; and the absence of light that has been absorbed by a species generated from a species immobilized on the probe. The presence of internal interfaces in probes employed to detect the above-described types of optical signals may undesirably reflect light back through the probe that has not impinged upon a species immobilized on the probe or generated from a species immobilized on a probe. Accordingly, probes lacking such internal interfaces (or including internal interfaces that reflect a relatively low amount of light) may be desirable for detecting such types of optical signals.

In some embodiments, an instrument is capable of operating and/or configured to operate in conjunction with one probe that comprises an internal interface and one probe that lacks an internal interface.

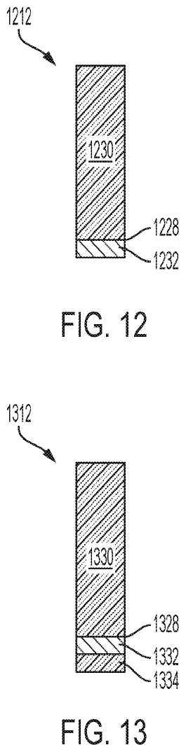

When present, interfaces internal to probes may have a variety of suitable designs. In some embodiments, a probe comprises an internal interface that takes the form of an interface between an interior portion of the probe and a coating disposed on the interior portion of the probe. FIG. 12 shows one non-limiting embodiment of a probe having such a design. The probe 1212 shown in FIG. 12 includes an internal interface 1228 between the interior portion of the probe 1230 and the coating 1232 disposed on the interior portion of the probe.

In some embodiments, a probe comprises a coating disposed on an interior portion of the probe and one or more further portions of the probe disposed on the coating. As one example, in some embodiments, a probe further comprises a second coating disposed on the coating disposed on the interior portion of the probe. The second coating may be formed from the same material as the interior portion of the probe. FIG. 13 shows one example of such a probe. In FIG. 13, the probe 1312 includes a second coating 1334 disposed on the coating 1332. As another example, and as described in further detail below, in some embodiments, one or more species are immobilized on the probe (not shown), such as on the end of the probe. Such species may facilitate the performance of one or more assays and/or may be capable of immobilizing and/or configured to immobilize one or more species.

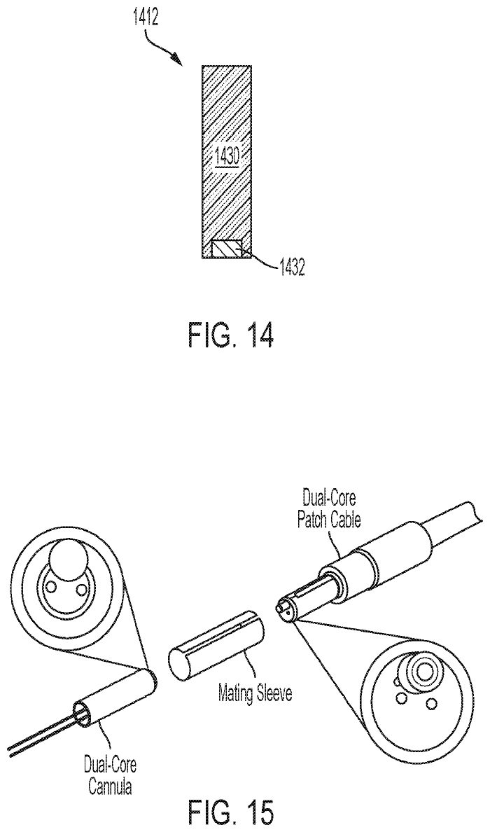

Probes and coatings thereon may have a variety of suitable shapes. As described above, in some embodiments, an internal interface extends only across a portion of the probe cross-section. In such embodiments, the probe may lack a coating at locations where the internal interface does not extend. Instead, the interior portion of the probe may extend to the end of the probe. For instance, with reference to FIG. 14, the probe 1412 includes a coating 1432 that only extends across a portion of its cross-section. The locations in the probe cross-sections lacking the coating instead include the same material forming the interior portion of the probe. In such embodiments, the internal interface only extends across the portions of the cross-section on which the coating is disposed.

Probes, internal interfaces thereto, and coatings may have a variety of suitable shapes. For instance, a probe, an internal interface, and/or a coating may have a hexagonal and/or a round cross-section. In some embodiments, an internal interface and/or a coating occupies a central portion of the probe cross-section or an external part of the probe cross-section that surrounds a central part of the probe cross-section free from the internal interface and/or the coating. It is also possible for an internal interface and/or a coating to occupy one or more sides of the probe (e.g., to extend from the center of the probe to one or more outer edges of the probe, to occupy the left half of the probe or the right half of the probe, etc.). In some embodiments, a probe comprises two optical fibers, one of which includes an internal interface and/or a coating and the other of which lacks internal interfaces and coatings. FIG. 15 shows one non-limiting example of such a probe design.

The various components of the probes described herein may have a variety of suitable compositions. In some embodiments, one or more portions of a probe (e.g., an interior portion, a coating, a second coating disposed on a coating disposed on an interior portion, the entirety of the probe) comprises a glass. Non-limiting examples of suitable glasses include SiO₂ and Ta₂O₅. In some embodiments, a probe comprises an interior portion and/or a second coating comprising SiO₂ and a coating comprising Ta₂O₅. In some embodiments, one or more portions of a probe (e.g., an interior portion, a coating, a second coating disposed on a coating disposed on an interior portion, the entirety of the probe) comprises a polymer. Non-limiting examples of suitable polymers include polystyrene and polyethylene.

The coatings described herein may have a variety of suitable thicknesses. In some embodiments, one or both of the coatings (and/or both coatings together) have a thickness of greater than or equal to 50 nm, greater than or equal to 100 nm, greater than or equal to 200 nm, greater than or equal to 500 nm, greater than or equal to 750 nm, greater than or equal to 1 micron, greater than or equal to 2 microns, greater than or equal to 3 microns, or greater than or equal to 4 microns. In some embodiments, one or both of the coatings (and/or both coatings together) have a thickness of less than or equal to 5 microns, less than or equal to 4 microns, less than or equal to 3 microns, less than or equal to 2 microns, less than or equal to 1 micron, less than or equal to 750 nm, less than or equal to 500 nm, less than or equal to 200 nm, or less than or equal to 100 nm. Combinations of the above-referenced ranges are also possible (e.g., greater than or equal to 50 nm and less than or equal to 5 microns, greater than or equal to 100 nm and less than or equal to 5 microns, or greater than or equal to 500 nm and less than or equal to 1 micron). Other ranges are also possible.

In some embodiments, a probe comprises a surface that is functionalized, that has a surface chemistry that assists with the performance of an assay, and/or has a surface chemistry that assists with the immobilization of a species thereon. The surface functionalization and/or chemistry may promote the immobilization thereon of reaction products that are typically generated during assays. For instance, the surface functionalization and/or chemistry may promote the immobilization of one or more species generated during the assay thereon. It is also possible for a surface functionalization and/or chemistry to promote the immobilization thereon of one or more species that may be present in a fluid with which the probe is in contact. In some embodiments, and as described above, a probe comprises a surface on which one or more species that are reagents are immobilized. The reagent(s) may be immobilized on the probe in a variety of suitable manners. As an example, the reagent(s) may be bonded to the probe. The bonding may comprise covalent bonding, ionic bonding, polar bonding, van der Waals bonding, hydrophobic bonding, and/or hydrogen bonding.

In some embodiments, one or more reagents(s) may be immobilized on a probe in a manner such that they do not undergo significant (and/or any) detachment from the probe upon contact with one or more fluids (e.g., a fluid present during the performance of assay, a fluid possibly comprising a species to be immobilized on the probe, a refunctionalization fluid). For instance, the reagent(s) may be immobilized on the probe in a manner that is stable to water, aqueous solutions, buffers, acids, bases, and/or bodily fluids. However, it is also possible for one or more reagents to be initially immobilized on a surface of a probe that are then released from the surface of the probe during contact with one or more of fluids. As an example, a reagent that is initially immobilized on a surface of a probe may be configured to be released from the probe upon exposure to a particular stimulus. The stimulus may be present in a fluid.

Additionally or alternatively, it is possible for one or more reagent(s) to be immobilized on a probe in a manner such that the probe can be refunctionalized. It is also possible for a method to comprise refunctionalizing a probe. Refunctionalizing may comprise removing one or more reagent(s) from the probe. For instance, in some embodiments, refunctionalization comprises exposing a probe on which one or more reagent(s) are immobilized to a fluid (e.g., a buffer, such as an acidic buffer) that causes one or more of those reagent(s) to be detached from the probe. Afterwards, the probe may be exposed to a fluid comprising one or more new reagent(s) to be immobilized on the probe. Refunctionalizing a probe may advantageously allow a probe to be employed during more than one method, during more than one assay, and/or to immobilize more than one type of analyte (e.g., as a non-consumable).

As an example, a first reagent and/or set of reagents may be immobilized on a probe prior to the performance of a first method, prior to the performance of a first assay. These reagents may be configured to undergo a chemical reaction with one or more species possibly present during the assay. If this chemical reaction does occur, the probe may be unsuitable for performing another assay unless it is refunctionalized because the chemical reaction may render the reagent(s) unsuitable for engaging in further chemical reactions. Accordingly, after performance of the assay, the probe may be refunctionalized to yield a probe onto which a new reagent and/or set of reagents can be immobilized, thus allowing for the probe to be employed during the performance of further assays. The reagent and/or set of reagents may be the same reagent and/or set of reagents initially immobilized on the probe, or may differ in one or more ways (e.g., if an operator desires to employ the probe to perform a different assay).

As another example, functionalizing a probe may advantageously allow a probe to be employed during more than one method and/or to immobilize more than one type of species. As an example, a first reagent and/or set of reagents may be immobilized on the probe prior to the determination of the concentration of a first species in a fluid. In some circumstances, it may be desirable to reuse the probe to determine the concentration of a second species in a fluid and/or a sample of the fluid (e.g., the same fluid as before, a different fluid). Accordingly, after detection of the concentration of the first species, the probe may be refunctionalized to yield a probe onto which a new reagent and/or set of reagents can be immobilized, thus allowing for the probe to be employed to detect the concentration of the second species.

It is also possible for some probes to not be regenerated and/or to be incapable of refunctionalization. Such probes may be employed as consumables.

A variety of suitable reagents may be immobilized on the surfaces of the probes described herein. In some embodiments, an instrument is configured to be employed with and/or capable of being employed with two or more probes. In such embodiments, the probes may have the same types of reagents immobilized on their surfaces, may have different reagents immobilized on their surfaces, and/or may have different combinations of reagents immobilized on their surfaces. The latter two possibilities may be particularly useful when the different probes are employed to detect different types of optical signals and/or different aspects of the fluids with which they are in contact (e.g., the presence, absence, and/or concentration of different species that may be present therein).

Some reagents may be species that are capable of that engaging in one or more chemical reactions (e.g., one or more chemical reactions that may take place during an assay that the probe is employed to facilitate). For instance, a probe may comprise a reagent that is capable of bonding with another species (e.g., covalently, ionically, by polar interactions, by van der Waals interactions, hydrophobically, by hydrogen bonding, by complexing), absorbing another species, adsorbing another species, catalyzing a reaction of another species and/or between two or more species, decomposing (e.g., upon exposure to another species), undergoing a conformational shift, and/or catalyzing a reaction. In some embodiments, one or more of the previously described chemical reactions may cause the species with which the reagent reacts to become immobilized thereon. Selected non-limiting examples of suitable reagents include biomolecules (e.g., proteins, glycoproteins, peptides, nucleic acids (e.g., DNA, RNA, mRNA), antibodies (e.g., antibodies for exosomes, such as anti-CD63 and/or anti-CD9, antibodies for proteins, antibodies for viruses, antibodies for virus-like particles), antibody fragments, antigens, polysaccharides, carbohydrates, hormones, streptavidin, glutathione), ligands (e.g., ligands for proteins, such as protein A), small molecules, viruses, cells, inorganic compounds (e.g., aminopropylsilane), sequestration compounds, capsids, bacteria resins (e.g., Ni-NTA), plasmids, nutrient components, metabolics, metabolic byproducts, and combinations thereof. Non-limiting examples of proteins include protein A, protein G, protein L, and lectin. One non-limiting example of a combination of two or more of the previously described reagent types is a reagent that comprises protein A and an antibody to an exosome and/or a virus. The antibody may be immobilized on protein A immobilized on a probe surface and may be capable of immobilizing an exosome and/or a virus. In such embodiments, as well as others, two or more reagents are immobilized on a probe (and, in some embodiments, one or more such reagents may be a combination of two or more reagents).

In some embodiments, a species immobilized on a surface of a probe is suitable for engaging in a chemical and/or biological reaction that comprises binding. It is also possible for a probe to be suitable for engaging in a chemical and/or biological reaction that does not comprise binding. When present, binding may comprise a reaction between a target and a binding partner that specifically binds to the target (e.g., an agent or molecule that specifically binds to the target). Binding may also comprise immobilizing a target on the binding partner. In some embodiments, the binding partner may specifically bind to an epitope on the target molecule. Non-limiting examples of specific pairs of binding partners and targets include an antibody and an antigen, an antibody fragment and an antigen, an antibody and a hapten, an antibody and a peptide, an antibody and a small molecule, an antigen and a fusion protein, an antibody fragment and a hapten, an enzyme and an enzymatic substrate, an enzyme and an inhibitor, an enzyme and a cofactor, a binding protein and a substrate, a carrier protein and a substrate, a protein and a small molecule, lecithin and a carbohydrate, a receptor and a hormone, a receptor and an effector, complementary strands of nucleic acid, a protein in combination with a nucleic acid repressor and an inducer, a ligand and a cell surface receptor, a virus and a ligand, and a receptor and a ligand.

Non-limiting examples of antibodies that may be binding partners or antibodies include intact (i.e., full-length) polyclonal and monoclonal antibodies, antigen-binding fragments of polyclonal and monoclonal antibodies (such as Fab, Fab', F(ab')2, or Fv), single chains (scFv) mutants of single chains, fusion proteins comprising an antibody portion, humanized antibodies, chimeric antibodies, diabodies, linear antibodies, single chain antibodies, multispecific antibodies (e.g., bispecific antibodies), and modified configurations of the immunoglobulin molecule that comprise an antigen recognition site of the required specificity. Non-limiting examples of antibodies falling into the last category include glycosylation variants of antibodies, amino acid sequence variants of antibodies, and covalently modified antibodies. Additionally, a binding partner may be an antibody of any class, such as IgD, IgE, IgG, IgA, or IgM (or subclass thereof, e.g., IgG1, IgG2, IgG3, IgG4, IgA1 and/or IgA2).

An antigen may be a molecule or a portion of a molecule that can have antibodies generated against it. Antigens may be peptides, polysaccharides and/or lipids. Some antigens may originate from within the body (a “self-antigen”), and some antigens may originate from the external environment (a “non-self-antigen”).

In some embodiments, antibodies suitable for performing a chemical and/or biological reaction specifically bind to epitopes on their target molecules. An epitope (which may be referred to as an antigenic determinant) may be the part of the antigen recognized (or bound by) an antibody. For example, the epitope may be the specific piece of the antigen to which an antibody binds. The part of an antibody that binds to the epitope may be referred to as a paratope. An epitope may be a conformational epitope (composed of discontinuous amino acids or sections of the antigen) or a linear epitope (composed of continuous amino acids). Some proteins may share segments of high sequence homology and/or structural similarity. These similar proteins may have common epitopes (in other words, the epitopes on different antibodies may be bound by the same antibody). Further, a protein that has been processed differentially (such as a protein that has gone a further enzymatic process) may share some, but not all epitopes with its pre-processing form. Non-limiting examples of different epitopes that may be added or removed during processing include N-terminal signal peptides (as seen, for example, on pre-pro-peptides) and changes seen when an inactive protein (e.g., a pro-peptide) is turned into an active form by post-translational modification.

When an antibody specifically binds to an epitope, it may engage in a binding reaction that is capable of discriminating between a target molecule and a non-target molecule. For example, a binding partner may specifically bind to a target molecule with greater than or equal to 2-fold greater affinity than to a non-target molecule with greater than or equal to 4-fold, greater than or equal to 5-fold, greater than or equal to 6-fold, greater than or equal to 7-fold, greater than or equal to 8-fold, greater than or equal to 9-fold, greater than or equal to 10-fold, greater than or equal to 20-fold, greater than or equal to 25-fold, greater than or equal to 50-fold, or greater than or equal to 100-fold greater affinity than to a non-target molecule.

The binding affinity of an antibody may be parametrized by its affinity (K_{D}). The K_{D} is the ratio of the dissociation constant to the association constant (K_{D}=K_{d}/Kₐ). In some embodiments, a binding partner described herein has an affinity (K_{D}) of less than or equal to 10⁻⁵ M, less than or equal to 10⁻⁶ M, less than or equal to 10⁻⁷ M, less than or equal to 10⁻⁸ M, less than or equal to 10⁻⁹ M, less than or equal to 10⁻¹⁰ M, less than or equal to 10⁻¹¹ M, or less than or equal to 10⁻¹² M. An increased affinity K_{D} corresponds to a decreased dissociation constant K_{d} or an increased association constant (Kₐ). Higher affinity binding of a binding partner (e.g., an antibody) to a first molecule relative to a second molecule can be indicated by a higher Kₐ (or a smaller numerical value of K_{D} and/or K_{d}) for binding to the first target than the Kₐ (or numerical value of K_{D} and/or K_{d}) for binding to the second target. In such cases, the antibody has a specificity for the first molecule (e.g., a protein in a first conformation or mimic thereof) relative to the second molecule (e.g., the same protein in a second conformation or mimic thereof, or a second protein). Differences in binding affinity (e.g., specificity) can be greater than or equal to 1.5-fold, greater than or equal to 2-fold, greater than or equal to 3-fold, greater than or equal to 4-fold, greater than or equal to 5-fold, greater than or equal to 10-fold, greater than or equal to 15-fold, greater than or equal to 20-fold, greater than or equal to 37.5-fold, greater than or equal to 50-fold, greater than or equal to 70-fold, greater than or equal to 80-fold, greater than or equal to 90-fold, greater than or equal to 100-fold, greater than or equal to 500-fold, greater than or equal to 1000-fold, greater than or equal to 10,000-fold, greater than or equal to 10⁵-fold.

In some embodiments, a reagent may be immobilized on a surface of a probe via a covalent bond. Prior to such immobilization, the surface of the probe may be functionalized such that it comprises a plurality of functional groups suitable for forming such covalent bonds. For instance, the surface of the probe may be functionalized by reaction with a bifunctional reagent comprising a siloxane group that facilitates attachment to the probe and a functional group that facilitates the formation of a covalent bond with the reagent to be immobilized on the probe. As another example, the surface of the probe may be exposed to a plasma or other treatment that generates functional groups in situ that facilitate the formation of a covalent bond with the reagent to be immobilized on the probe. Non-limiting examples of suitable types of functionals group that facilitate the formation of a covalent bond with the reagent to be immobilized on the probe include hydroxyls, amines, and carboxyls.

The probes described herein may comprise optical fibers having a variety of suitable diameters. In some embodiments, a probe comprises an optical fiber having a core with a diameter of greater than or equal to 400 microns, greater than or equal to 500 microns, greater than or equal to 600 microns, greater than or equal to 700 microns, greater than or equal to 800 microns, greater than or equal to 900 microns, greater than or equal to 1000 microns, greater than or equal to 1100 microns, greater than or equal to 1200 microns, greater than or equal to 1300 microns, greater than or equal to 1400 microns, greater than or equal to 1500 microns, greater than or equal to 1600 microns, greater than or equal to 1700 microns, greater than or equal to 1800 microns, or greater than or equal to 1900 microns. In some embodiments, a probe comprises an optical fiber having a core with a diameter of less than or equal to 2000 microns, less than or equal to 1900 microns, less than or equal to 1800 microns, less than or equal to 1700 microns, less than or equal to 1600 microns, less than or equal to 1500 microns, less than or equal to 1400 microns, less than or equal to 1300 microns, less than or equal to 1200 microns, less than or equal to 1100 microns, less than or equal to 1000 microns, less than or equal to 900 microns, less than or equal to 800 microns, less than or equal to 700 microns, less than or equal to 600 microns, or less than or equal to 500 microns. Combinations of the above-referenced ranges are also possible (e.g., greater than or equal to 400 microns and less than or equal to 2000 microns). Other ranges are also possible.

As described elsewhere herein, some instruments may be suitable for performing assays and some methods may comprise performing assays (e.g., with the use of an instrument described herein).

In some embodiments, the performance of an assay comprises contacting one or more probes with one or more fluids (and, in some embodiments, subsequently removing the one or more probes from contact with such fluid(s)) and detecting one or more optical signals. In some embodiments, an assay comprises detecting two optical signals of two different types. For instance, an assay may comprise detecting a first type of optical signal that comprises an amount of the first type of light that has been reflected from an interface internal to a probe and an amount of the first type of light that has been reflected from the end of the probe and a second, different type of optical signal. The second type of optical signal may comprise: an amount of light that has been transmitted, reflected, scattered, and/or polarized from a species immobilized on a probe; an amount of the light that has been transmitted, reflected, scattered, and/or polarized from a species generated from a species immobilized on a probe; the absence of light that has been absorbed by a species immobilized on the first probe; and/or the absence of an amount of light that has been absorbed by a species generated from a species immobilized on a probe. The two types of optical signals may be generated in conjunction with the same probe or with two different probes.

In some embodiments, two types of optical signals detected during the performance of an assay are employed for different purposes. For example, one type of optical signal (e.g., an optical signal that may be generated relatively quickly, such as an optical signal that comprises an amount of the first type of light that has been reflected from an interface internal to a probe and an amount of the first type of light that has been reflected from the end of the probe) may be employed to perform quality control and a second type of optical signal (e.g., an optical signal that may be detected relatively precisely and/or that can provide information regarding a reaction that cannot be detected via the first type of optical signal) may be employed to determine the result of the assay. The quality control may comprise assessing the quality of the probe employed to make the measurement. It is also possible that quality control may comprise assessing the quality of one or more assay steps, such as blocking steps, detection antibody addition steps, secondary antibody addition steps, and/or incubation steps.

Other combinations of purposes for which first and second signals may be employed are also possible. For instance, in some embodiments, an assay comprises detecting one type of optical signal that is present to be employed to determine when the next step of the assay can be performed (e.g., when incubation can be terminated) and a second type of optical signal that is employed to determine the result of the assay. As another example, in some embodiments, an assay comprises detecting a first type of optical signal that is indicative of binding of a first species (e.g., a species present in a fluid with which the probe is in contact) to a second species immobilized on the probe and a second type of optical signal that is indicative of a reaction between the first species and a third species (e.g., a species present in a different fluid with which the probe is subsequently contacted). Such a reaction may comprise the generation of a precipitate that absorbs light and/or of a new species that results in the generation of an optical signal.

It is also possible for different types of optical signals to be employed to determine different features of different samples and/or for one type of optical signal to be employed to determine a feature of a sample and another type of optical signal to be employed to determine a feature of a standard. The latter types of optical signals may assist with calibrating an instrument and/or detecting if an instrument is functioning properly. It is also possible for a method to comprise comparing a signal indicative of a feature of a sample to a signal indicative of a feature of a standard. Such comparisons may be useful for subtracting out background noise and/or enhancing measurement reproducibility.

Other examples of methods that comprise detecting two optical signals include methods in which no optical signals arise from any samples. Such methods may be methods in which exclusively reference, background, and/or baseline optical signals are detected. In such embodiments, a method may comprise calibrating an instrument, assessing instrument functionality, and/or generating a set of data that may be employed to normalize and/or calibrate data obtained from samples.

During assay performance, an optical signal may be associated with a species immobilized on a probe and/or a species present in a fluid with which the probe is in contact. In some embodiments, an optical signal is detected while a probe is in contact with a fluid. It is also possible for an optical signal to be generated upon initial contact between a probe and a fluid. In some embodiments, detection of an optical signal comprises detecting the location at which the optical signal was generated. This may be accomplished by detecting a position of a probe transmitting the optical signal to a detector and/or by detecting the location of a detector detecting the optical signal.

When a probe is contacted with two or more fluids, it may be removed from contact with each fluid with which it they in contact with before contacting the next fluid. In some embodiments, removing a probe from contact with a fluid stops a reaction from occurring (e.g., a reaction between a species immobilized on a probe and a species present in the fluid from which the probe is removed). Stopping a reaction by removing a probe from contact with a fluid may be performed in response to an optical signal (e.g., an optical signal indicative of the fluid and/or a sample with which the probe was in contact prior to contacting the fluid). It is also possible for a reaction to be stopped by removing a probe from contact with a fluid after a preset interval has elapsed and/or by manual action of an operator.

The sequential contacting of a probe with two or more fluids may be effectuated by translating the probe(s), a probe handling system, and/or a support structure. The translating may be performed according to a pre-set program in which the probe is positioned at a plurality of locations for a plurality of times. It is also possible for an instrument to be configured such that an operator can translate the probe at will (e.g., an operator may be able to input a desired location to which the probe is translated location and/or to move the probe in real time by use of a controller). Additionally, some instruments may be configured such that they are not configured to translate a probe. In such embodiments, the probe may be stationary or immovable absent manual movement by an operator.

Pre-set programs may comprise some or all of the following sequential steps: translating the probe horizontally (e.g., in a first horizontal direction, in a second horizontal direction perpendicular to the first horizontal direction, in a combination of the two directions) until it is positioned above a container and/or a portion thereof (e.g., a well in a multi-well plate), either pausing for a defined amount of time (during which the container may be raised such that any fluid in the portion of the container, such as a well therein, contacts the probe) or lowering the probe until it contacts any fluid in the portion of the container (e.g., well), maintaining the probe in a position such that it contacts any fluid in the portion of the container (e.g., well) for a defined amount of time, and either pausing for a defined amount of time (during which the container may be lowered such that any fluid in the portion of the container, such as a well, no longer contacts the probe) or raising the probe until it no longer contacts any fluid in the portion of the container (e.g., well). Pre-set programs may repeat the above some or all of these sequential steps such that the probe sequentially contacts a plurality of fluids contained in a plurality of containers and/or portions thereof (e.g., a plurality of wells in a multi-well plate). Further examples of steps that pre-set programs may comprise include pre-wet (e.g., coating dissolution), initiation, calibration, reference, and/or shut-down steps.

As noted elsewhere herein, some methods comprise employing two probes. Such embodiments may relate to employing two probes to conduct a common assay and/or two probes to conduct two distinct assays (which may be of the same type and/or performed on the same sample, which may be of different types, and/or which may be performed on different samples). In such embodiments, a second probe may also be contacted with one or more of fluids and a second optical signal (e.g., of the same type detected by the first probe, of a different type) may be detected. The second probe may be removed from contact with each fluid with which it is in contact before contacting the next fluid. In some embodiments, a second optical signal is detected while a probe is in contact with a fluid.

Some assays comprise detecting one or more qualitative features of a sample (e.g., the presence absence of a species of interest, such as a protein). Some assays comprise detecting one or more quantitative features of a sample (e.g., the amount of a species of interest present in the sample, such as the amount of a protein present in the sample). In some embodiments, an assay comprises performing a kinetic measurement (e.g., the rate of binding of a species in a fluid, such as a sample, to a species immobilized on a probe) and/or a pulse measurement. In some embodiments, an assay comprises performing a pulse measurement, such as a measurement performed during a flash luminescence reaction and/or a flash reaction. Some suitable flash luminescence reactions and flash reactions comprise contacting a probe with a species immobilized thereon that is a catalyst for a reaction and then measuring an optical signal associated with a species generated by that reaction.

A variety of suitable assays may be performed, non-limiting examples of which include ELISA assays (e.g., direct ELISA assays, indirect ELISA assays, sandwich ELISA assays), whole cell assays, biomolecular interaction assays, kinase assays, ligand receptor assays, cytotoxicity assays, hybridization assays, immunoassays, and functional assays. Some assays may comprise detecting cell surface proteins, empty capsids, and/or capsids containing nucleic acids. In some embodiments, a system described herein may be capable of performing and/or automating a commercially available assay, such as the DELFIA® (dissociation-enhanced lanthanide fluorescence immunoassay) Time-Resolved Fluorescence assay. Similarly, some methods may comprise performing a commercially available assay (e.g., in an automated manner).

In some embodiments, an assay is performed on a sample. In such embodiments, at least one fluid with which a probe is contacted during the assay may comprise a fluid that is a sample. The sample may be a fluid with which a probe is contacted and/or may be present in (e.g., suspended in, dissolved in) one fluid with which a probe is contacted. It is also possible for two or more (or each) pluralities of fluids employed in an assay to comprise a fluid that is a sample (e.g., in the case where performing the assay comprises employing two or more probes to each contact its own plurality of samples). In some embodiments, performing an assay comprises contacting at least one probe with at least one plurality of fluids that lack any fluids that are samples.

In some embodiments, a sample comprises a component that becomes immobilized on a probe during performance of the assay and/or is configured to become immobilized on a probe during performance of the assay. For instance, in some embodiments, a sample comprises a component that binds to a probe and/or is configured to bind to a probe. It is also possible for the performance of an assay to determine whether or not a sample comprises such components. For instance, in some embodiments, a sample may comprise an antigen for an antibody immobilized on a probe. Performing the assay may identify whether the sample in fact comprises an antigen and/or the concentration of such an antigen in the sample. As further examples, as described above, a reagent may be immobilized on a surface of a probe that is suitable for engaging in a chemical and/or biological reaction that comprises binding, and the sample may comprise a binding partner and/or target for that reagent. For instance, an antigen may be immobilized on the surface of a probe and the sample may comprise an antibody for that antigen (e.g., an enzyme-linked antibody for that antigen).

Some samples may comprise bodily fluids and/or biological materials. As an example, in some embodiments, a sample comprises cells (e.g., live cells) and/or reagents (e.g., biomolecules). Samples may comprise some or all of the reagents described elsewhere herein with respect to the reagents that may be immobilized on the surface of a probe and/or may comprise reagents other than those so described. Non-limiting examples of some reagents that may be included in samples suitable for being analyzed by an assay include proteins (e.g., protein A, protein G, protein L, host cell proteins, Fc receptors, streptavidin), glycoproteins, peptides, ligands, antibodies (e.g., IgG), antigens, small molecules, viruses, capsids, cells, (e.g., Chinese hamster ovary cells), differentiated cell types, polysaccharides, bacteria, hormones, nucleic acids (e.g., DNA, RNA, mRNA), carbohydrates, small molecules, inorganic compounds, ions (e.g., nickel ions), sequestration compounds, and bacteria. In some embodiments, a fluid comprises a reagent that is a protein tagged by a recombinant modification. Non-limiting examples of tagged proteins include His-tagged proteins and biotin-tagged proteins (e.g., biotinylated proteins).

The fluids described herein may comprise a species with which an optical signal is associated at a variety of suitable concentrations. In some embodiments, a fluid comprises a species with which an optical signal is associated at a concentration of greater than or equal to 0.000001 g/L, greater than or equal to 0.000002 g/L, greater than or equal to 0.000005 g/L, greater than or equal to 0.0000075 g/L, greater than or equal to 0.00001 g/L, greater than or equal to 0.00002 g/L, greater than or equal to 0.00005 g/L, greater than or equal to 0.000075 g/L, greater than or equal to 0.0001 g/L, greater than or equal to 0.0002 g/L, greater than or equal to 0.0005 g/L, greater than or equal to 0.00075 g/L, greater than or equal to 0.001 g/L, greater than or equal to 0.002 g/L, greater than or equal to 0.005 g/L, greater than or equal to 0.0075 g/L, greater than or equal to 0.01 g/L, greater than or equal to 0.02 g/L, greater than or equal to 0.05 g/L, greater than or equal to 0.075 g/L, greater than or equal to 0.1 g/L, greater than or equal to 0.2 g/L, greater than or equal to 0.5 g/L, greater than or equal to 0.75 g/L, greater than or equal to 1 g/L, greater than or equal to 1.5 g/L, greater than or equal to 2 g/L, greater than or equal to 2.5 g/L, greater than or equal to 3 g/L, greater than or equal to 3.5 g/L, greater than or equal to 4 g/L, greater than or equal to 4.5 g/L, greater than or equal to 5 g/L, greater than or equal to 6 g/L, greater than or equal to 7.5 g/L, greater than or equal to 10 g/L, greater than or equal to 15 g/L, greater than or equal to 20 g/L, greater than or equal to 30 g/L, or greater than or equal to 40 g/L. In some embodiments, a fluid comprises a species with which an optical signal is associated at a concentration of less than or equal to 5 g/L, less than or equal to 50 g/L, less than or equal to 40 g/L, less than or equal to 30 g/L, less than or equal to 20 g/L, less than or equal to 15 g/L, less than or equal to 10 g/L, less than or equal to 7.5 g/L, less than or equal to 6 g/L, less than or equal to 5 g/L, less than or equal to 4.5 g/L, less than or equal to 4 g/L, less than or equal to 3.5 g/L, less than or equal to 3 g/L, less than or equal to 2.5 g/L, less than or equal to 2 g/L, less than or equal to 1.5 g/L, less than or equal to 1 g/L, less than or equal to 0.75 g/L, less than or equal to 0.5 g/L, less than or equal to 0.2 g/L, less than or equal to 0.1 g/L, less than or equal to 0.075 g/L, less than or equal to 0.05 g/L, less than or equal to 0.02 g/L, less than or equal to 0.01 g/L, less than or equal to 0.0075 g/L, less than or equal to 0.005 g/L, less than or equal to 0.002 g/L, less than or equal to 0.001 g/L, less than or equal to 0.00075 g/L, less than or equal to 0.0005 g/L, less than or equal to 0.0002 g/L, less than or equal to 0.0001 g/L, less than or equal to 0.000075 g/L, less than or equal to 0.00005 g/L, less than or equal to 0.00002 g/L, less than or equal to 0.00001 g/L, less than or equal to 0.0000075 g/L, less than or equal to 0.000005 g/L, or less than or equal to 0.000002 g/L. Combinations of the above-referenced ranges are also possible (e.g., greater than or equal to 0.000001 g/L and less than or equal to 50 g/L). Other ranges are also possible.

It is also possible for an assay to be performed on a standard. For instance, in some embodiments, an assay is performed on a positive standard and/or a negative standard. Positive standards may be configured to always yield an optical signal and/or to always yield an optical signal at a known intensity and/or polarization if the assay is performed correctly. Some positive standards comprise a known concentration of a reagent to be detected by the assay. Negative standards may be configured to always yield no optical signal if the assay is performed correctly. Some positive standards lack a reagent to be detected by the assay. The performance of an assay on a positive standard and/or a negative standard may be useful for calibrating the results obtained from an assay performed on a sample and/or to confirm that an instrument is performing properly. Some embodiments may comprise contacting a probe with a plurality of fluids that comprises a sample (and, optionally, lacks a standard) and a probe (e.g., the same probe that contacts the plurality of fluids that comprises the sample, a different probe) with a plurality of fluids that comprises a standard (and, optionally, lacks a sample). It is also possible for an embodiment to comprise contacting two or more standards (e.g., with one or more probes, in a manner such that a single probe contacts all standards, or such that each probe contacts a single standard), such as both a positive standard and a negative standard and/or two or more positive standards comprising differing concentrations of a reagent to be detected by the assay.

Fluids other than samples and standards that may be present during the performance of an assay include fluids that comprise species that assist with the performance of the assay. As an example, fluids that comprise one or more reagents (e.g., one or more reagents of the type described elsewhere herein with respect to the types of reagents that may be immobilized on probes) may be present. Such fluids may be provided separately from any samples and/or standards (e.g., in a separate well in a multi-well plate). Additionally, such fluids may comprise a reagent configured to be immobilized on a species immobilized on a probe. As one example, such fluids may comprise a reagent configured to be immobilized on a species initially immobilized on a probe. The reagent present in the fluid may be a reagent that is configured to undergo a reaction with a species that may be present in a sample. The reaction may comprise immobilizing the reagent present in the sample thereon (i.e., on the species initially present in the fluid). As another example, a fluid may comprise a reagent that is configured to be immobilized on a reagent initially present in a sample. Such a reagent may be immobilized on the probe via the reagent initially present in the sample. Such a reagent may be configured to generate an optical signal and/or to react with a further reagent to generate an optical signal.

Non-limiting examples of reagents that may be present in fluids described herein and/or configured to be immobilized on a species immobilized on a probe include ligands (e.g., ligands for analytes present in the sample), binding partners and/or targets for analytes present in samples, antibodies (e.g., antibodies for antigens present in the sample, enzyme-linked antibodies, primary enzyme-linked antibodies, secondary enzyme-linked antibodies, enzyme-linked antibodies for antigens present in samples, antibodies comprising fluorophores), proteins, glycoproteins, peptides, nucleic acids, antigens, polysaccharides, carbohydrates, hormones, small molecules, viruses, cells, inorganic compounds, sequestration compounds, capsids, and bacteria. In some embodiments, a reagent comprises an enzyme and/or is bonded to an enzyme. Non-limiting examples of suitable enzymes include horseradish peroxidase and alkaline phosphatase.

In some embodiments, a fluid that comprises one or more reagents configured to generate an optical signal is present during the performance of an assay. Such fluids may be provided separately from any samples, standards, and/or fluids comprising species that assist with the performance of the assay (e.g., in a separate well in a multi-well plate), one or more reagents, and/or fluids comprising species that assist with the performance of the assay. One example of such a fluid is a fluid that comprises a reagent that is configured to react with a species immobilized on a probe (e.g., a reagent initially present in a sample, a species immobilized on a reagent initially present in the sample). Reagents configured to react with reagents immobilized on a probe may generate an optical signal upon undergoing such a reaction. For instance, a fluid may comprise a reagent configured to undergo a reaction with a species immobilized on a probe that generates a species that absorbs light, transmits light, reflects light, fluoresces light, undergoes scattering (e.g., Raman scattering), is polarized, and/or undergoes luminescence (e.g., chemiluminescence). In some embodiments, an optical signal is detected while a probe is in contact with a fluid that comprises one or more reagents configured to generate an optical signal and/or upon initial contact with such a fluid.

Non-limiting examples of reagents that may be configured to generate an optical signal include enzyme substrates (e.g., for enzyme-linked antibodies) and biomolecules modified to exhibit fluorescence (e.g., europium-labeled streptavidin). Some methods comprise reacting an enzyme substrate with an enzyme (e.g., an enzyme-linked antibody). Such a reaction may result in the generation of products of an enzymatic reaction, one or more of which may be capable of and/or configured to generate an optical signal. Some methods comprise immobilizing a fluorescent reagent (e.g., a biomolecule modified to exhibit fluorescence) on a probe.

In some embodiments, one or more wash fluids is present during the performance of an assay. Wash fluids may be provided separately from any samples, standards, fluids comprising species that assist with the performance of the assay, and/or fluids comprising reagents configured to generate an optical signal (e.g., in a separate well in a multi-well plate), one or more standards, one or more reagents, fluids comprising species that assist with the performance of the assay, and/or fluids comprising reagents configured to generate an optical signal. A wash fluid may be a fluid that is configured to remove species that are weakly adhered to a probe.

Removing such species from a probe may enhance the reproducibility of the assay by eliminating signal from a species that is not immobilized on thereon. Additionally, removing such species from a probe may reduce cross-contamination between different fluids present during the assay. One example of a suitable wash fluid is a wash buffer (e.g., a glycin buffer, a phosphoric acid buffer).

In some embodiments, an assay is conducted by sequentially contacting a probe on which a reagent is immobilized with the following fluids: a sample comprising a first reagent configured to be immobilized on the probe, a fluid comprising a second reagent configured to become immobilized on the first reagent, and a fluid comprising a third reagent configured to react with the second reagent to generate a species that generates an optical signal. As another example, an assay may comprise sequentially contacting a probe on which a reagent is immobilized with the following fluids: a sample comprising a first reagent configured to be immobilized on the probe, a fluid comprising a second reagent configured to become immobilized on the first reagent, a fluid comprising a third reagent configured to become immobilized on the second reagent, and a fluid comprising a fourth reagent configured to react with the third reagent to generate a species that generates an optical signal. It is also possible for a process to be performed in which a standard is the first fluid contacted by the probe but for which the other steps are the same as those in one of the preceding two sentences. Additionally, some methods may comprise contacting a probe with a wash fluid (e.g., a wash buffer) in between two or more of pairs of the steps described above.

The fluids employed during the assays described herein may be contained in a variety of suitable containers. In some embodiments, some or all of such fluids are contained in one or more multi-well plates. In such embodiments, the fluids may be contained in separate wells.

The wells may be in a single common row, a common set of rows, a single common column, or a common set of columns. In embodiments in which two or more pluralities of fluid are contacted, each plurality of fluids may be positioned as described above (e.g., each plurality of fluids may be positioned in a single common row, a common set of rows, a single common column, or common set of columns). It is also possible for a method to comprise contacting one or more probes with a plurality of fluids that are positioned in two or more columns or two or more rows. It is also possible for the fluids to be contained in other types of articles as described elsewhere herein. During performance of the assay, one or more probes may be translated across one or more containers containing a plurality of fluids and/or a support structure on which one or more such container(s) are supported may be translated with respect to one or more probes. For instance, in the case of a multi-well plate, one or more probes may be translated across a plurality of wells in the multi-well plate. Some or all of those wells may contain the fluids employed to perform the assay. As another example, a support structure on which a multi-well plate is supported may be translated so that a plurality of wells (some or all of which contain fluids suitable for performing the assay) are sequentially positioned proximal to one or more probes.

Performance of an assay may also comprise one or more steps and/or periods of time in which both a support structure and one or more probes are stationary, in which all parts of the instrument are stationary, in which two or more parts of the instrument are stationary with respect to each other, and/or in which two or more parts of the instrument (despite being non-stationary with respect to each other) do not experience appreciable net displacement from each other. As an example, in some embodiments, a method comprises one or more periods of time during which a probe is incubated with a fluid. The incubation may occur while both the probe and the fluid (and, possibly, a container containing the fluid and/or a support structure supporting such a container) are stationary. It is also possible for the incubation to occur while either the fluid (and, possibly, a container containing the fluid and/or a support structure supporting such a container) and/or a probe are shaking. In some embodiments, both the fluid (and, possibly, a container containing the fluid and/or a support structure supporting such a container) and the probe shake together. In some embodiments, incubation comprises agitating the fluid (e.g., a sample) and/or mixing the fluid. The agitation and/or mixing may be accomplished by stirring the fluid (e.g., with the probe).

It is also possible for incubation to comprise adjusting and/or maintaining the temperature of the fluid. For instance, incubation may comprise heating the fluid and/or cooling the fluid.

In some embodiments, an optical signal may be generated and/or detected during one or more steps and/or periods of time in which both a support structure and a probe are stationary, in which all parts of the instrument are stationary, in which two or more parts of the instrument are stationary with respect to each other, and/or in which two or more parts of the instrument (despite being non-stationary with respect to each other) do not experience appreciable net displacement from each other. The detection may occur during incubation and/or in the absence of incubation.

### Example 1

This Example describes an exemplary instrument.

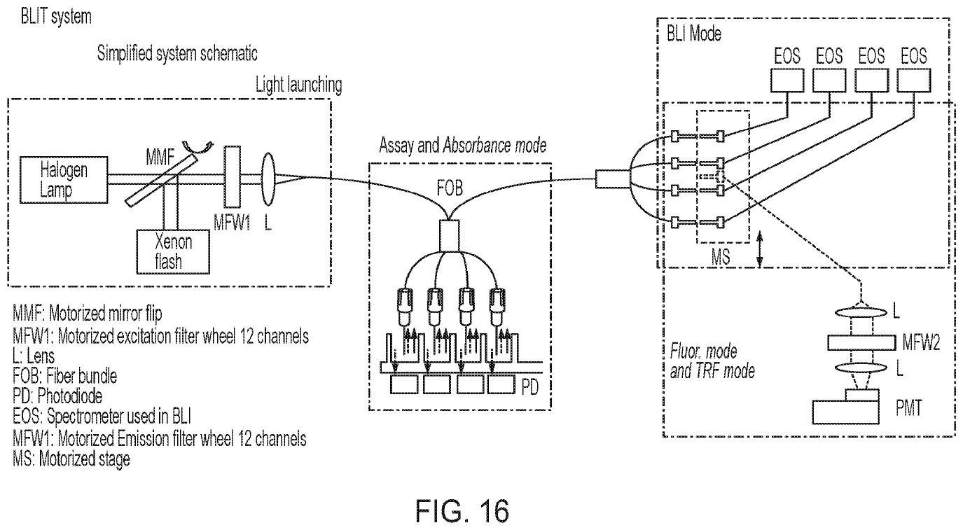

The exemplary instrument is depicted in FIG. 16. As can be seen in FIG. 16, the instrument comprises two groups of probes. The first group of probes is configured to be employed for the generation of optical signals comprising the absence of an amount that has been absorbed (i.e., for the performance of an absorbance measurement). The second group of probes is configured to be employed for the generation of optical signals comprising light that has been emitted due to fluorescence (i.e., for the performance of a fluorescence measurement, such as a time-resolved fluorescence measurement) and for the generation of optical signals comprising light that has been reflected from an interface internal to the probe and light that has been reflected from the end of the probe (i.e., for the performance of an interference measurement). The instrument also comprises two light source systems and three groups of optical detector systems, providing combinations of light source systems and optical detector systems suitable for performing these different types of optical measurements.

During operation, the identity of the light source system that is employed can be selected by employing a motorized mirror flip to place the desired light source system in optical communication with the probes. The detectors are placed such that, when the probe from which they receive light is illuminated by the appropriate light source system, the desired optical signal may be detected. Probes and/or groups of probes may be translated between different locations (e.g., corresponding to different samples and/or different fluids employed during an assay) by a motorized stage.

### Example 2

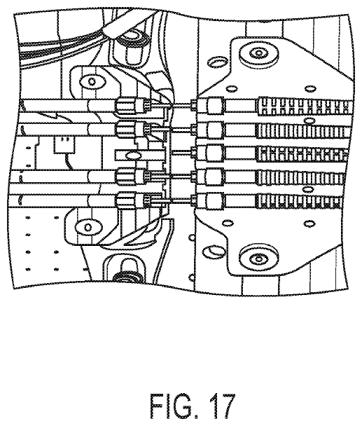

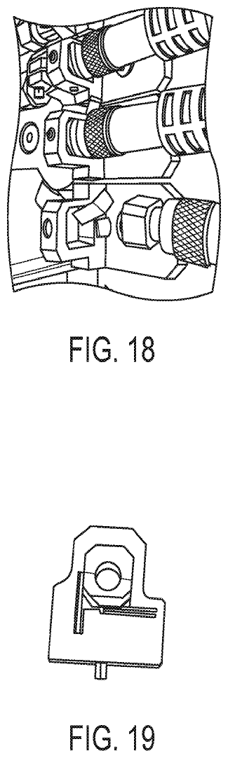

This Example includes photographs of exemplary optical switches. Such switches may be employed as light source system switches and/or optical detector system switches. These optical switches are shown in FIGS. 17-19.

### Example 3

This Example describes the performance of a time-resolved fluorescent measurement employing an instrument described herein.

An instrument described herein was employed to perform DELFIA® time-resolved fluorescence measurements on samples comprising curopium-labeled streptavidin with DELFIA® Enhancement Solution at varying concentrations. These measurements were performed in conjunction with a probe on which europium-labeled streptavidin was immobilized. The Enhancement Solution was used to create a fluorescent Europium chelate in DELFIA® TRF assays. The light source system comprised a Xenon flash lamp and a 350±30 nm filter. The optical detector system comprised a photomultiplier tube and a 630±20 nm filter. 100 stimulating light pulses were supplied, and the optical signals detected subsequently were averaged. Time-resolved fluorescence measurements for the same samples comprising europium-labeled streptavidin with DELFIA® Enhancement Solution were also performed on an iD5 microplate reader from Molecular Devices. During these measurements, the samples comprising europium-labeled streptavidin with DELFIA® Enhancement Solution were positioned in plates and placed in the microplate reader.

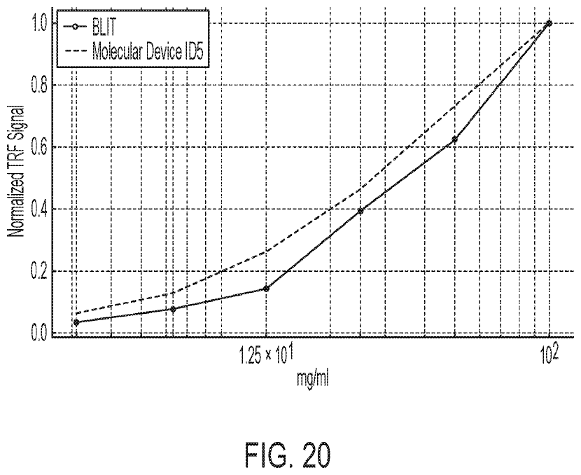

As can be seen from FIG. 20, the instrument described herein was able to obtain normalized time-resolved fluorescence signals that varied with samples comprising europium-labeled streptavidin with DELFIA® Enhancement Solution in substantially the same manner as those obtained using the iD5 microplate reader. This indicates that the instruments described herein are suitable for performing time-resolved fluorescence measurements.

### Example 4

This Example describes the performance of a time-resolved fluorescent assay employing an instrument described herein.

An instrument described herein was employed to perform all steps of the DELFIA® Time-Resolved Fluorescence assay prior to the time-resolved fluorescence (TRF) measurements. During the assay, a probe as described herein was contacted sequentially with the fluids present in the assay in the order prescribed by the assay. During these steps, optical signals comprising light that has been reflected from an interface internal to the probe and light that has been reflected from the end of the probe were recorded. Then, the probe was dipped into DELFIA® Enhancement Solution and time-resolved fluorescence measurements were performed on with the use of an iD5 microplate reader from Molecular Devices. The samples subjected to the assay comprised biotinylated Bovine Serum Albumin (BSA) and europium-labeled streptavidin at varying concentrations.

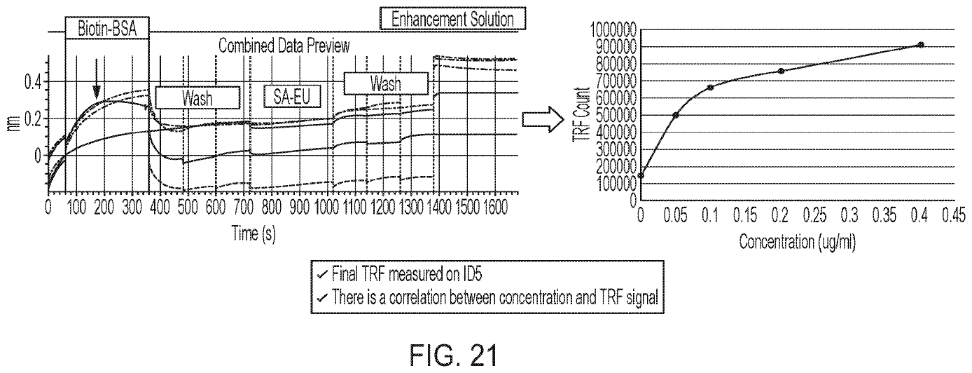

The left-hand panel of FIG. 21 depicts the optical signals for each sample recorded during the assay as a function of time during different steps of the assay. As can be seen from the left-hand panel of FIG. 21, the initial immobilization of biotinylated BSA on the probe resulted in an observable increase in the optical signal and the subsequent washing of the probe resulted in an observable decrease in the optical signal. This indicates that the instruments described herein are capable of detecting the immobilization of species on the probe and the amount of such species with a high level of precision. The subsequent exposures to europium-labeled streptavidin, washing, and exposure to the DELFIA® Enhancement Solution also resulted in observable optical signals, further indicating the capabilities of such instruments. It can also be seen that these optical signals exhibited intensities that varied with the concentration of the samples being assayed, showing the capability of the assay to yield information about this parameter.

The right-hand panel of FIG. 21 depicts the final, time-resolved fluorescence measurements for each sample. It can be seen that these time-resolved fluorescence measurements are able to easily discriminate between different concentrations of samples comprising biotinylated Bovine Serum Albumin (BSA) and europium-labeled streptavidin. This further confirms that the instrument employed to perform the previous steps of the assay resulted in the immobilization of distinguishable amounts of biotinylated BSA and europium-labeled streptavidin on the probes. As a result, there is a correlation between concentration and time-resolved fluorescence signal.

This Example also demonstrates the successful combination of time-resolved fluorescence measurements with dip-and-read measurements for optical signals comprising light that has been reflected from an interface internal to the probe and light that has been reflected from the end of the probe.

### Example 5

This Example describes the performance of an absorption assay employing an instrument described herein.

An instrument described herein was employed to perform all steps of the Octet Anti-CHO Host Cell Protein Detection (HCP) assay, except that a TMB (3,3′,5,5′-tetramethylbenzidine) ELISA substrate was employed instead of Metal Dab. During the assay, a probe as described herein was contacted sequentially with the fluids present in the assay in the order prescribed by the assay except for the above-described change. During these steps, optical signals comprising light that has been reflected from an interface internal to the probe and light that has been reflected from the end of the probe were recorded. Then, the probe was dipped into the TMB substrate and buffer, and absorption measurements were performed by an iD5 microplate reader. The samples subjected to the assay comprised HCP at varying concentrations.

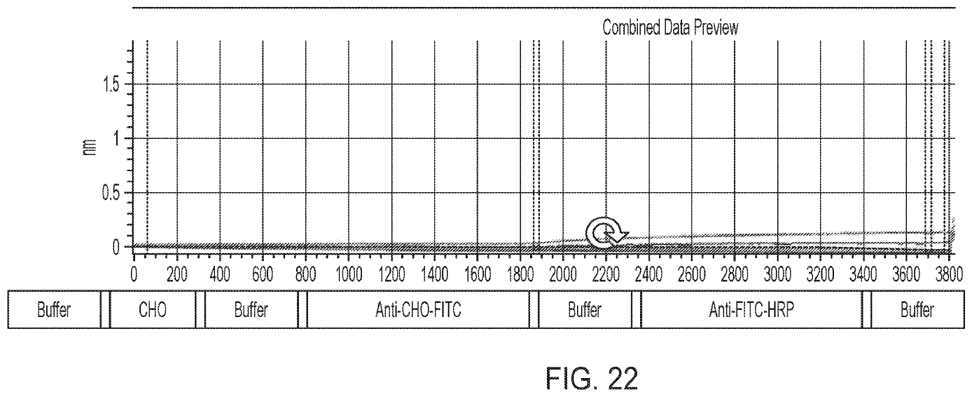

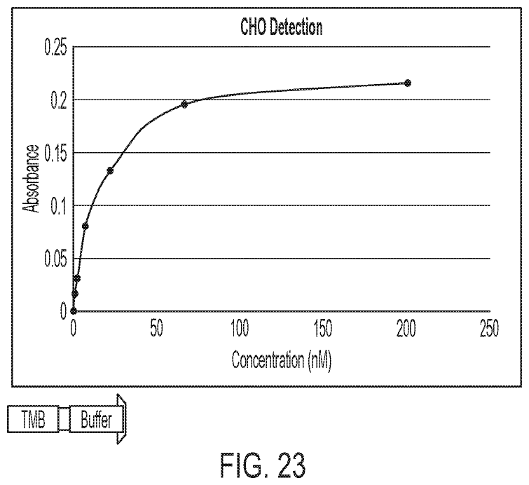

FIG. 22 shows the optical signals for each sample recorded during the assay as a function of time during different steps of the assay and FIG. 23 shows the final absorbance optical signals for each sample (i.e., after the further addition of the TMB substrate and buffer). As can be seen by comparing these two Figures, although little change in the optical signal was observed during the initial assay steps and little difference between the samples was observed during these steps, the different amounts of HCP in the different samples was readily distinguishable in the final absorption step. This indicates that there is a correlation between concentration and absorbance.

This Example also demonstrates the successful combination of absorbance measurements with dip-and-read measurements for optical signals comprising light that has been reflected from an interface internal to the probe and light that has been reflected from the end of the probe. This combination may be particularly useful when some types of optical signals are obtained with larger magnitude than others. For instance, during the detection of larger biomolecules that give weak interference signals.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law. As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. An instrument, comprising:
a first light source system configured to emit a first type of light;
a second light source system configured to emit a second type of light;
a first optical detector system configured to detect a first type of optical signal; and
a second optical detector system configured to detect a second type of optical signal,
wherein the first type of optical signal comprises an amount of the first type of light that has been reflected from an interface internal to a first probe and an amount of the first type of light that has been reflected from the end of the first probe, and
wherein the second type of optical signal comprises:
an amount of the second type of light that has been transmitted, reflected, scattered, and/or polarized from a species immobilized on the first probe,
an amount of the second type of light that has been transmitted, reflected, scattered, and/or polarized from a species generated from a species immobilized on the first probe,
the absence of an amount of the second type of light that has been absorbed by a species immobilized on the first probe, and/or
the absence of an amount of the second type of light that has been absorbed by a species generated from a species immobilized on the first probe.

2. A method, comprising:
detecting a first type of optical signal with a first optical detector system; and
detecting a second type of optical signal with a second optical detector system,
wherein the first type of optical signal comprises an amount of a first type of light reflected from an interface internal to a first probe and an amount of the first type of light reflected from the end of the first probe, and
wherein the second type of optical signal comprises:
an amount of a second type of light that has been transmitted, reflected, scattered, polarized, and/or emitted from a species immobilized on the first probe,
an amount of the second type of light that has been transmitted, reflected, scattered, polarized, and/or emitted from a species generated from a species immobilized on the first probe,
the absence of an amount of the second type of light that has been absorbed by a species immobilized on the first probe, and/or
the absence of an amount of the second type of light that has been absorbed by a species generated from a species immobilized on the first probe.

3-4. (canceled)

5. An instrument, comprising:
a first light source system configured to emit a first type of light;
a first optical detector system configured to detect a first type of optical signal; and
a second optical detector system configured to detect a second type of optical signal,
wherein the first type of optical signal comprises an amount of the first type of light that has been reflected from an interface internal to a first probe and an amount of the first type of light that has been reflected from the end of the first probe, and
wherein the second type of optical signal comprises:
an amount of a second type of light that has been emitted from a species immobilized on the first probe, and/or
an amount of the second type of light that has been emitted from a species generated from a species immobilized on the first probe.

6. An instrument, comprising:
a first light source system configured to emit a first type of light;
a first optical detector system configured to detect a first type of optical signal; and
a second optical detector system configured to detect a second type of optical signal,
wherein the first type of optical signal comprises an amount of the first type of light that has been reflected from an interface internal to a first probe and an amount of the first type of light that has been reflected from the end of the first probe, and
wherein the second type of optical signal comprises:
an amount of a second type of light that has been emitted from a species immobilized on a second probe different from the first probe, and/or
an amount of the second type of light that has been emitted from a species generated from a species immobilized on the second probe.

7. (canceled)

8. An instrument, comprising:
a first light source system configured to emit a first type of light;
a first optical detector system configured to detect a first type of optical signal; and
a second optical detector system configured to detect a second type of optical signal,
wherein the first type of optical signal comprises an amount of the first type of light that has been reflected from an interface internal to a first probe and an amount of the first type of light that has been reflected from the end of the first probe,
wherein the second type of optical signal comprises an amount of a second type of light that has been emitted from a species immobilized on a second probe and/or an amount of the second type of light that has been emitted from a species generated from a species immobilized on the second probe; and
wherein the second probe is the same probe as the first probe or is a different probe from the first probe.

9. (canceled)

10. An instrument as in claim 6, wherein the instrument comprises one probe handling system that is configured to translate the first and second probes together.

11. An instrument as in claim 6, wherein the instrument comprises a first probe handling system that is configured to translate the first probe and a second probe handling system that is configured to translate the second probe.

12. (canceled)

13. An instrument as in claim 1, wherein the interface internal to the first probe extends across the entirety of the cross-section of the first probe.

14. An instrument as in claim 1, wherein the interface internal to the first probe extends partially across the cross-section of the first probe, and wherein a portion of the cross-section of the first probe lacks the interface internal to the first probe.

15. (canceled)

16. An instrument as in any claim 1, wherein the interface internal to the first probe takes the form of an interface between an interior portion of the first probe and a coating disposed on the interior portion of the first probe.

17-19. (canceled)

20. An instrument as in claim 1, wherein a reagent is immobilized on the first probe.

21. An instrument as in claim 6, wherein a reagent is immobilized on a second probe.

22. An instrument as in claim 6, wherein the first probe and/or the second probe is capable of transmitting and/or configured to transmit light from the first light source system and/or the second light source system through the probe and/or to a fluid.

23. An instrument as in claim 6, wherein the first probe and/or the second probe is capable of transmitting and/or configured to transmit light from a fluid and/or through the probe to the first optical detector system and/or the second optical detector system.

24-26. (canceled)

27. An method as in claim 2, wherein the first type of optical signal is detected before the second type of optical signal.

28. An method as in claim 2, wherein the first and second types of optical signals are detected simultaneously.

29. An method as in claim 2, wherein the first and second types of optical signals are detected when the first probe is in contact with the same fluid.

30. An method as in claim 2, wherein the first and second types of optical signals are detected when the first probe is in contact with different fluids.

31-34. (canceled)

35. An instrument as in claim 1, wherein the instrument further comprises a support structure.

36-42. (canceled)

43. An instrument as in claim 1, wherein the second light source system is configured to emit a third type of light.

44-65. (canceled)
